(19) United States
(12) Patent Application Publication
(10) Pub. No.: US 2017/0372230 A1
(43) Pub. Date: Dec. 28, 2017

(54) MACHINE LEARNING MANAGEMENT METHOD AND MACHINE LEARNING MANAGEMENT APPARATUS

(71) Applicant: FUJITSU LIMITED, Kawasaki-shi (JP)

(72) Inventors: Nobuyuki KUROMATSU, Kawasaki (JP); Haruyasu Ueda, Ichikawa (JP)

(73) Assignee: FUJITSU LIMITED, Kawasaki-shi (JP)

(21) Appl. No.: 15/604,821

(22) Filed: May 25, 2017

(30) Foreign Application Priority Data
Jun. 22, 2016 (JP) 2016-123674

(51) Int. Cl. G06N 99/00; G06N 5/04; G06F 17/11

(52) U.S. Cl. CPC G06N 99/005; G06F 17/11; G06N 5/04

(57) ABSTRACT

A machine learning management apparatus calculates, for each of a plurality of second models that are generated by model searches by a plurality of algorithms using a plurality of sets of second training data and based on prediction performance of first models, an index value used to determine whether to generate each second model. The machine learning management apparatus then sets the number of second models that are generated using a set of second training data and have an index value at least equal to a threshold as the priority for caching that second training data. The machine learning management apparatus then decides, when a model search has been executed using second training data, whether to cache the second training data based on the priority and stores the second training data in a memory when the decision to cache the data is taken.

### CROSS-REFERENCE TO RELATED APPLICATION

This application is based upon and claims the benefit of priority of the prior Japanese Patent Application No. 2016-123674, filed on Jun. 22, 2016, the entire contents of which are incorporated herein by reference.

### FIELD

The embodiments discussed herein are related to a machine learning management method and a machine learning management apparatus.

### BACKGROUND

In recent years, machine learning has been one example of a field where there are high expectations for technologies that process big data. The expression “machine learning” refers to analyzing data to identify a data trend (or “model”), comparing unknown data that has been newly acquired with the model, and predicting the output.

Machine learning is composed of two phases, a learning phase and a prediction phase. The learning phase uses training data as an input and outputs a model. In the prediction phase, a prediction is made based on the model outputted from the learning phase and prediction data. The ability to correctly predict the result of an unknown case (hereinafter, this ability is referred to as “prediction performance”) improves as the size of the training data used during learning increases. On the other hand, as the size of the training data increases, the learning time taken to produce a model also lengthens. For this reason, a method called progressive sampling has been proposed in order to efficiently obtain a model with sufficient prediction performance for practical use.

With progressive sampling, a computer first learns a model using training data of a small size. The computer evaluates the prediction performance of the learned model using test data that indicates known cases that differ from the training data, based on a comparison between results predicted by the model and the known results. When the prediction performance is not sufficient, the computer learns another model using training data that is larger than in the previous learning. By repeating the above process until a sufficiently high prediction performance is achieved, it is possible to avoid using training data of an excessively large size, which makes it possible to reduce the learning time taken to produce a model. As a technology relating to machine learning, it is possible to conceive of a distributed computing system with an improved processing speed achieved by avoiding launching and ending the learning process and accompanying data loads that occur when the learning process is iteratively executed. A learning system that learns efficiently through selective sampling, and a learning data generating method capable of generating learning data for stacking without increasing the load of learning data generation would also be conceivable. In addition, it would also be possible to perform learning with a hierarchical neural network whose general-purpose applicability can be improved by simple methods.

See, for example, the following documents.

Japanese Laid-open Patent Publication No. 2012-22558

Japanese Laid-open Patent Publication No. 2009-301557

Japanese Laid-open Patent Publication No. 2006-330935

Japanese Laid-open Patent Publication No. 2004-265190

Foster Provost, David Jensen, and Tim Oates, “Efficient Progressive Sampling”, Proc. of the 5th International Conference on Knowledge Discovery and Data Mining, pp. 23-32, Association for Computing Machinery (ACM), 1999

To increase the prediction performance, it is important to select an appropriate machine learning algorithm for the data in question. To select an appropriate machine learning algorithm, as one example, generation of a model and evaluation of the model are repeatedly executed while changing the machine learning algorithm used on the same data. The series of processes that generates and evaluates a model using a selected machine learning algorithm is hereinafter referred to as a “model search”.

When a model search is repeatedly performed, there are cases where data that has been generated by a model search procedure executed in the past is repeatedly used. This means that by storing the data generated by a model search in a cache, it becomes possible to reuse the data. However, there is a limit on the capacity of a cache and it is not possible to cache all of the data. Also, typical cache algorithms such as LRU (Least Recently Used) do not consider the procedure of model searches performed during machine learning, so that data is insufficiently reused during machine learning.

### SUMMARY

According to one aspect, there is provided a non-transitory computer-readable storage medium storing a computer program that causes a computer to perform a procedure including: generating a plurality of first models by executing a model search according to each of a plurality of machine learning algorithms using first training data out of a plurality of sets of training data that have different sampling rates; calculating, based on a prediction performance of each of the plurality of first models, an index value to be used to determine whether to generate each of a plurality of second models, which are generated by model searches according to the plurality of algorithms using a plurality of sets of second training data that are included in the plurality of training data but differ from the first training data, the index value being separately calculated for each of the plurality of second models; setting, for each of the plurality of sets of second training data, the number of second models for which the index value is equal to or above a threshold, out of the second models generated using the second training data, as a priority for caching the second training data; deciding, when a model search has been executed using a new set of second training data that is not cached, whether to cache the new set of second training data based on the priority of the new set of second training data; and storing, when the deciding has decided to cache the new set of second training data, the new set of second training data in a memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an example configuration of a machine learning management apparatus according to a first embodiment;

FIG. 2 depicts an example configuration of a parallel distributed processing system according to a second embodiment;

FIG. 3 depicts an example configuration of hardware of a master node;

FIG. 4 is a graph depicting an example of the relationship between sampling size and prediction performance;

FIG. 5 is a graph depicting an example relationship between learning time and prediction performance;

FIG. 6 depicts one example of an execution order when a speed improvement-prioritizing search is performed for a plurality of machine learning algorithms;

FIG. 7 depicts a first example of an execution order of model searches;

FIG. 8 depicts a second example of an execution order of model searches;

FIG. 9 depicts an example of transitions in a cache state when an LRU policy is used;

FIG. 10 is a block diagram depicting a machine learning function of the parallel distributed processing system according to the second embodiment;

FIG. 11 is a flowchart depicting the overall procedure of machine learning;

FIG. 12 depicts a first example of a planned number of executions of each learning step;

FIG. 13 depicts a second example of the planned number of executions of each learning step;

FIG. 14 depicts a third example of the planned number of executions of each learning step;

FIG. 15 depicts a fourth example of the planned number of executions of each learning step;

FIG. 16 is a flowchart depicting the detailed procedure of machine learning;

FIG. 17 is a flowchart depicting the procedure of a model searching process according to a speed improvement-prioritizing search;

FIG. 18 is a flowchart depicting one example of the calculation procedure of speed improvement in prediction performance;

FIG. 19 depicts a fifth example of the planned number of executions for each learning step;

FIG. 20 is a first diagram depicting example transitions in a cache state resulting from cache control according to the second embodiment;

FIG. 21 is a second diagram depicting example transitions in the cache state resulting from cache control according to the second embodiment;

FIG. 22 is a third diagram depicting example transitions in the cache state resulting from cache control according to the second embodiment;

FIG. 23 depicts a first example of initial prediction results;

FIG. 24 depicts a first example of prediction results after measured values have been reflected;

FIG. 25 depicts a second example of initial prediction results;

FIG. 26 depicts a second example of prediction results after measured values have been reflected;

FIG. 27 depicts a third example of prediction results after measured values have been reflected;

FIG. 28 depicts a third example of initial prediction results;

FIG. 29 depicts a fourth example of prediction results after measured values have been reflected; and

FIG. 30 depicts an example of a display screen for a usage state of the cache.

### DESCRIPTION OF EMBODIMENTS

Several embodiments will be described below with reference to the accompanying drawings, wherein like reference numerals refer to like elements throughout. Note that the embodiments described below may be implemented where possible in combination.

### First Embodiment

A first embodiment will now be described. This first embodiment promotes the reuse of data that has been cached. For this reason, the difficulty involved in reusing cached data will be described first.

Typically, the larger the number of algorithms used during a model search, the higher the precision of the model that is obtained. On the other hand, the larger the number of algorithms subjected to a model search, the greater the amount of computation performed for machine learning. In particular, when performing machine learning on big data, the data size increases beyond the amount of data that is handled by a single machine. For this reason, a model search is performed using parallel distributed processing. Since many iterations of processing are executed during machine learning, middleware of parallel distributed processing that is capable of executing processing on data held in memory is used. In this way, an arrangement where data is subjected to processing while being held in memory is called “caching”. With the caching function achieved by middleware, intermediate results obtained during data processing are held in local memories of servers or on a local disk to enable reuse of the data. In cases where the same data is subjected to other processing, it becomes unnecessary to regenerate the data, resulting in a potential reduction in processing time.

When the training data used in a model search according to a plurality of algorithms is sampled using progressive sampling, effective use is made of the cache provided by middleware of in-memory parallel distributed processing. As one example, processing efficiency is improved by caching training data that has been sampled for a model search according to a specified algorithm and then reusing the training data in a model search according to a different algorithm.

Note that when progressive sampling is used, since a plurality of sets of training data are generated while gradually increasing the size of the training data, there is the risk of the storage capacity of the cache becoming depleted, so that caching all of the training data is not possible. In this case, some of the training data is deleted from the cache. As one example, when an LRU policy is applied, data with the oldest last access time is deleted. In cases where a model search is performed according to a plurality of algorithms for a set of training data every time a set of training data is generated, cache control according to an LRU policy is effective.

Note that when a model search is performed according to a plurality of algorithms for a set of training data every time a set of training data is generated, there is the risk that a large amount of redundant learning that does not contribute to improvements in prediction performance of the model that is finally used will be performed, which would result in the learning time becoming excessively long. For this reason, to reduce the number of times that a redundant model search is performed, it would be conceivable for example to preferentially proceed with a model search with a set of training data with a large data size using machine learning algorithm that are expected to have a large improvement in prediction performance (“speed improvement in prediction performance”).

However, when a model search with a set of training data with a large data size is preferentially performed for an algorithm with a large speed improvement in prediction performance, it is not possible to make efficient use of cached training data according to LRU cache control. That is, when a model search that uses training data with a large data size has been performed, other training data is deleted to create space for caching the present training data. After this, when a model search that uses training data with a small data size is performed according to another machine learning algorithm, the training data has to be regenerated, leading to an increase in processing. Accordingly, for this situation where model searches are executed according to a plurality of algorithms using a plurality of sets of training data, there is demand for a cache control technology that makes it possible to efficiently reuse cached training data, even when model searches are performed in an order that prevents redundant model searches from being executed.

For this reason, in this first embodiment, when data is generated by the procedure of a model search, the number of times this data will used by subsequent model searches is predicted and data with a high number of uses is preferentially cached. This makes it possible to promote the reuse of cached data.

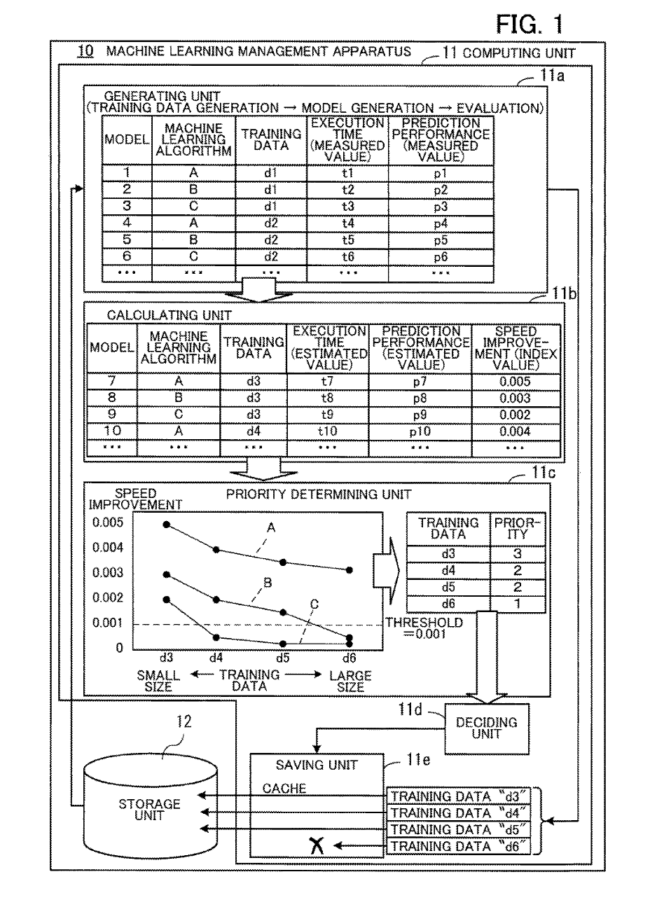

FIG. 1 depicts an example configuration of a machine learning management apparatus according to the first embodiment. A machine learning management apparatus 10 includes a computing unit 11 and a storage unit 12. The computing unit 11 includes a generating unit 11a, a calculating unit 11b, a priority determining unit 11c, a deciding unit 11d, and a saving unit 11e.

The generating unit 11a generates a plurality of first models by executing a model search according to each of a plurality of machine learning algorithms using first training data, which is one set out of a plurality of sets of training data that have different sampling rates. After generating the plurality of first models, the generating unit 11a selects a target second model to be generated out of a plurality of second models based on respective index values of the plurality of second models. As one example, the model with the highest index value is selected. The generating unit 11a then generates the target second model by executing a model search according to a machine learning algorithm for generating the target second model, using second training data for generating the target second model. As one example, the generating unit 11a repeatedly selects a target second model and generates this target second model until there are no more second models with an index value that is equal to or greater than a threshold.

The calculating unit 11b sets models generated by model searches according to a plurality of algorithms using a plurality of sets of second training data that are included in the plurality of sets of training data but differ from the first training data, as second models. Based on the prediction performance of each of the plurality of first models, the calculating unit 11b then calculates, for each of the plurality of second models, an index value that is used to determine whether to generate the second model in question. As one example, the calculating unit 11b calculates, for each of the plurality of second models, a speed improvement in prediction performance based on the time taken to generate the second model in question and the prediction performance of the second model, and sets the speed improvement as the index value of the second model.

The priority determining unit 11c sets, for each of the plurality of sets of second training data, the number of second models, out of the second models to be generated using the second training data in question, with an index value equal to or greater than a threshold as the priority for caching the second training data in question.

When a model search is executed using new second training data that has not been cached, the deciding unit 11d decides whether the new second training data is to be cached based on the priority of the new second training data. As one example, the deciding unit 11d arranges the set or plurality of sets of existing second training data that has/have already been cached and the new second training data into descending order of priority. When the total data size of the sets of existing second training data positioned before the new second training data in the priority order and the new second training data is equal to or less than the cache capacity (i.e., the capacity of the storage unit 12), the deciding unit 11d decides to cache the new second training data.

When the decision to cache the new second training data has been taken but there is insufficient free space in the storage unit 12, the deciding unit 11d decides which training data to delete from the storage unit 12. One example of when there is insufficient free space in the storage unit 12 is a case where the total data size of all of the existing second training data and the new second training data exceeds the cache capacity. As one example, when the decision has been taken to cache the new second training data but there is insufficient free space in the storage unit 12, the deciding unit 11d decides to delete existing second training data with a lower priority than the new second training data from the cache region.

When the decision to cache data has been taken, the saving unit 11e saves the new second training data in the cache region of the storage unit 12. At this time, when the decision has been taken to delete some of the existing second training data, the saving unit 11e deletes the second training data in question from the storage unit 12.

The storage unit 12 stores the cached training data. The storage capacity of the storage unit 12 is the cache capacity.

In the machine learning management apparatus 10, as one example the generating unit 11a performs model searches according to three machine learning algorithms called “A”, “B”, and “C”. It is assumed here that a model search includes generation of the training data to be used in generating a model, generation of the model itself, and evaluation of the model. Note that when the training data to be used is already stored in the storage unit 12, the generating unit 11a acquires the training data to be used from the storage unit 12 instead of generating the training data.

Note that in the example in FIG. 1, training data “d1” and “d2” are set as sets of first training data. Training data “d3” to “d6” are set as sets of second training data. It is also assumed that out of the training data, “d1” has the smallest data size and “d6” has the largest data size.

When machine learning starts, the generating unit 11a executes a model search using the machine learning algorithms “A”, “B”, and “C” using the two sets of training data “d1” and “d2”. As a result, six models numbered “1” to “6” are generated as the first models. For each of the generated models, the generating unit 11a also finds the respective execution times “t1” to “t6” of model searches that generated the models and the respective prediction performances “p1” to “p6” of the models.

The calculating unit 11b calculates index values used to determine whether to generate each of the second models that are yet to be generated using the second training data. In the example in FIG. 1, when the index value of a second model is equal to or above a threshold of “0.001”, a model search that generates this second model is performed.

When speed improvement is used as the index value, the calculating unit 11b estimates, from the execution time when generating a first model according to a specified machine learning algorithm, the execution time of a model search taken when generating a second model according to the same machine learning algorithm. As one example, it is possible to estimate the execution time from the difference in the data size of the training data being used. As one example, based on the prediction performance of the first models of a specified machine learning algorithm, the calculating unit 11b finds an expression that expresses the relationship between the data size of the training data used in model generation and the prediction performance of the models generated by that machine learning algorithm. Based on the expression associated with a machine learning algorithm, it is possible to estimate the prediction performance of a model that is generated when a model search is performed according to that machine learning algorithm using the second training data. Here, the improvement in the prediction performance caused by generating a second model is found by subtracting the highest prediction performance of the first models from the estimated prediction performance of the second model. A value produced by dividing the improvement caused by a second model by the execution time of that second model is the “speed improvement” of the second model.

Once the index values have been calculated, the priority determining unit 11c calculates, for each set of training data, the number of second models whose index values are equal or greater than the threshold, out of the second models generated using that set of training data. This calculation result is used as the priority of each set of training data. In the example in FIG. 1, out of the second models generated using the training data “d3”, there are three models where the speed improvement is equal to or greater than the threshold “0.001”, so that the priority of the training data “d3” is “3”. Out of the second models generated using the training data “d4”, there are two models where the speed improvement is equal to or greater than “0.001”, so that the priority of the training data “d4” is “2”. Out of the second models generated using the training data “d5”, there are two second models where the speed improvement is equal to or greater than “0.001”, so that the priority of the training data “d5” is “2”. Out of the second models generated using the training data “d6”, there is one model where the speed improvement is equal to or greater than “0.001”, so that the priority of the training data “d6” is “1”.

After this, the generating unit 11a performs a model search using the second training data. As one example, the second model with the highest speed improvement is specified, a model search is executed by the machine learning algorithm for generating this second model using the training data used when generating this second model. In the example in FIG. 1, a model search is executed according to the machine learning algorithm “A” using the training data “d3” to generate the model “7”. When doing so, the training data “d3” is generated by data sampling from original data.

When the training data “d3” has been generated, the deciding unit 11d decides whether to cache the training data “d3”. In the example in FIG. 1, the priority of the training data “d3” is “3” and since this is the highest, the decision is taken to cache the training data “d3”. When the decision is taken to cache the data, the saving unit 11e stores the training data “d3” in the storage unit 12. That is, the training data “d3” is cached.

After this, as examples, a model search according to the machine learning algorithm “A” using the training data “d4”, a model search according to the machine learning algorithm “A” using the training data “d5”, and a model search according to the machine learning algorithm “A” using the training data “d6” are performed in that order. It is assumed here that the free space in the storage unit 12 after the training data “d4” and the training data “d5” have been cached is less than the data size of the training data “d6”. Since the priority of the training data “d6” is “1”, which is the lowest, the decision is taken to not cache the data. As a result, the training data “d6” is not cached and is discarded.

By performing cache control in this way, it is possible to correctly discard the training data “d6” that has no possibility of being subsequently reused. Here, when an LRU policy is used, the most recently used training data “d6” would not be cached. Instead, other training data would be deleted from the cache. However, when reuse of a set of training data with high priority is planned and that set of training data is deleted from the cache, the same training data has to be generated when performing a model search using this training data, which lowers the processing efficiency. On the other hand, according to the machine learning management apparatus 10 depicted in FIG. 1, since the training data “d6” is discarded without being cached, it is possible to avoid deletion of other sets of training data, which improves the processing efficiency.

Note that whenever a model search that uses a set of second training data is executed, the calculating unit 11b may recalculate the index value of each second model that is yet to be generated based on the prediction performance of each of the plurality of first models and the prediction performance of existing second models that have already been generated. By doing so, the calculation precision of priority is improved. As a result, the processing efficiency of machine learning is improved.

It is also possible to cache the original data used to generate sets of training data in the storage unit 12. Here, when the new second training data is the only set of second training data with a priority of 1 or higher and the total data size of the original data and the new second training data exceeds the cache capacity, the deciding unit 11d decides to delete the original data from the cache region. By doing so, when there is no longer any possibility of the original data being used for data sampling, the original data is deleted from the storage unit 12, which makes it possible to provide free space for caching other training data. As a result, it is possible to cache training data that will be reused, which improves the efficiency of processing through the reuse of training data.

Note that as one example, the computing unit 11 is a processor provided in the machine learning management apparatus 10. Also, the generating unit 11a, the calculating unit 11b, the priority determining unit 11c, the deciding unit 11d, and the saving unit 11e are realized by processing executed by a processor provided in the machine learning management apparatus 10. As one example, it is possible to realize the storage unit 12 by a memory or a storage apparatus provided in the machine learning management apparatus 10.

The lines that join the elements depicted in FIG. 1 depict only some of the communication paths in the machine learning management apparatus 10, and it is also possible to set other communication paths aside from the illustrated examples.

### Second Embodiment

A second embodiment will now be described. The second embodiment executes a model search using progressive sampling for a plurality of machine learning algorithms as part of machine learning on big data. In the second embodiment, machine learning is executed by a parallel distributed processing system.

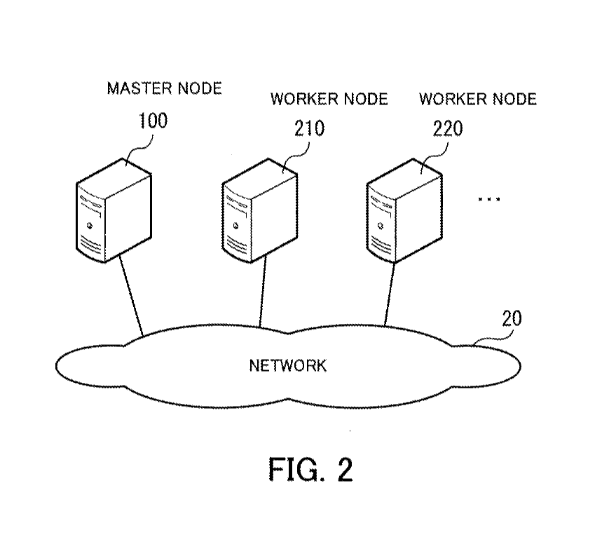

FIG. 2 depicts an example configuration of a parallel distributed processing system according to the second embodiment. As one example, the parallel distributed processing system includes one master node 100 and a plurality of worker nodes 210, 220, . . . . The master node 100 and the plurality of worker nodes 210, 220, . . . are connected by a network 20. The master node 100 is a computer that controls the distributed processing executed for machine learning. The worker nodes 210, 220, are computers that execute processing of an execution system for machine learning according to parallel processing.

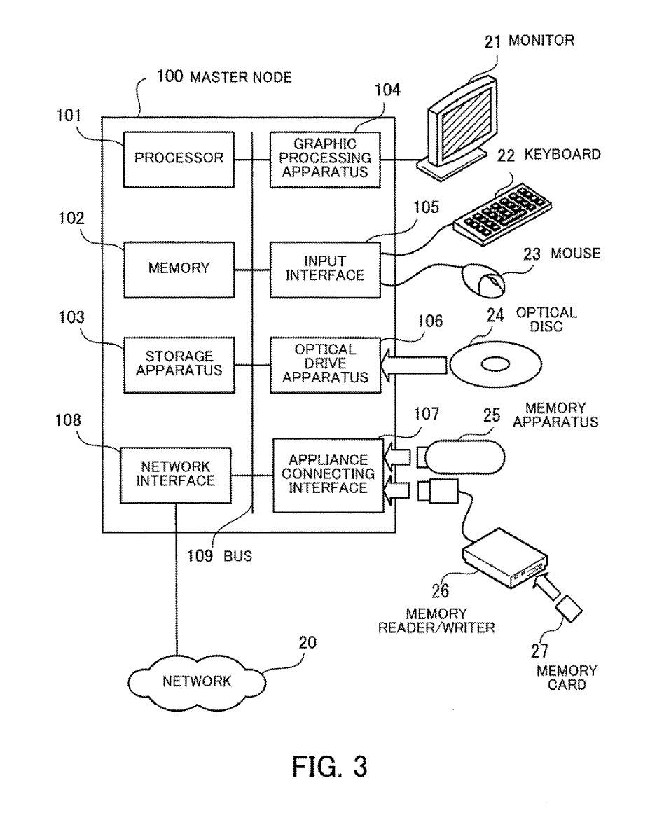

FIG. 3 depicts an example configuration of hardware of a master node. The entire master node 100 is controlled by the processor 101. The processor 101 is connected via a bus 109 to a memory 102 and a plurality of peripherals. The processor 101 may be a multiprocessor. As examples, the processor 101 is a CPU (Central Processing Unit), an MPU (Micro Processing Unit), or a DSP (Digital Signal Processor). At least some of the functions that are realized by the processor 101 executing a program may be realized by electronic circuitry such as an ASIC (Application Specific Integrated Circuit) or a PLD (Programmable Logic Device).

The memory 102 is used as the main storage apparatus of the master node 100. At least part of an OS (Operating System) program to be executed by the processor 101 and application programs is temporarily stored in the memory 102. Various data used in processing by the processor 101 is also stored in the memory 102. As one example, a volatile semiconductor storage apparatus such as RAM (Random Access Memory) is used as the memory 102.

The peripherals connected to the bus 109 include a storage apparatus 103, a graphic processing apparatus 104, an input interface 105, an optical drive apparatus 106, an appliance connecting interface 107, and a network interface 108.

The storage apparatus 103 performs electrical or magnetic reads and writes of data on an internal storage medium. The storage apparatus 103 is used as an auxiliary storage apparatus of a computer. An OS program, an application program, and various data are stored in the storage apparatus 103. Note that as examples of the storage apparatus 103, it is possible to use an HDD (Hard Disk Drive) or an SSD (Solid State Drive).

The graphic processing apparatus 104 is connected to a monitor 21. The graphic processing apparatus 104 displays images on the screen of the monitor 21 in accordance with instructions from the processor 101. Examples of the monitor 21 include a display apparatus that uses a CRT (Cathode Ray Tube) and a liquid crystal display apparatus.

A keyboard 22 and a mouse 23 are connected to the input interface 105. The input interface 105 transmits signals sent from the keyboard 22 and the mouse 23 to the processor 101. Note that the mouse 23 is merely one example of a pointing device, and it is possible to use another pointing device. Other examples of a pointing device include a touch panel, a tablet, a touch pad, and a trackball.

The optical drive apparatus 106 uses laser light or the like to read data that has been recorded on an optical disc 24. The optical disc 24 is a portable recording medium on which data is recorded so as to be capable of being read using reflected light. Examples of the optical disc 24 include a DVD (Digital Versatile Disc), a DVD-RAM, a CD-ROM (Compact Disc Read Only Memory), and a CD-R (Recordable)/RW (ReWritable).

The appliance connecting interface 107 is a communication interface for connecting peripherals to the master node 100. As examples, a memory apparatus 25 and a memory reader/writer 26 are connected to the appliance connecting interface 107. The memory apparatus is a recording medium equipped with a function for communicating with the appliance connecting interface 107. The memory reader/writer 26 is an apparatus that writes data on a memory card 27 and/or reads data from the memory card 27. The memory card 27 is a card-shaped recording medium.

The network interface 108 is connected to the network 20. The network interface 108 transmits and receives data to and from another computer or communication device via the network 20.

With the hardware configuration described above, it is possible to realize the processing functions of the master node 100 according to the second embodiment. Note that the worker nodes 210, 220, . . . can also be realized by the same hardware as the master node 100 depicted in FIG. 3. The machine learning management apparatus 10 described in the first embodiment can also be realized by the same hardware as the master node 100 depicted in FIG. 3.

As one example, the master node 100 and the worker nodes 210, 220, . . . realize the processing functions of the second embodiment by executing programs recorded on computer-readable recording media. Programs in which the processing content to be executed by the master node 100 and the worker nodes 210, 220, is written may be recorded in advance on various recording media. As one example, the program to be executed by the master node 100 is stored in advance in the storage apparatus 103. The processor 101 loads at least part of the program in the storage apparatus 103 into the memory 102 and executes the program. The program to be executed by the master node 100 can also be recorded on a portable recording medium such as the optical disc 24, the memory apparatus 25, and the memory card 27. As one example, the program stored on the portable recording medium is executed after being installed in the storage apparatus 103 according to control from the processor 101. It is also possible for the processor 101 to directly read and execute a program from a portable recording medium.

Next, the relationship between the sampling size, the prediction performance, and the learning time for machine learning will be described, along with the method of progressive sampling.

For the machine learning in the second embodiment, a plurality of data units indicating known cases are collected in advance. An apparatus in the parallel distributed processing system or a different information processing apparatus may collect data from various devices, such as sensor devices, via the network 20. The collected data may be data of a large size typically referred to as “big data”. Each data unit normally includes the values of two or more explanatory variables and the value of one objective variable. As one example, for machine learning that forecasts demand of a product, actual data with factors that affect product demand, such as temperature and humidity, as the explanatory variables and product demand as the objective variable is collected.

The parallel distributed processing system samples some of the data units out of the collected data as the training data to learn a model using the training data. The model indicates the relationship between the explanatory variables and the objective variable and normally includes two or more explanatory variables, two or more coefficients, and one objective variable. The model may be expressed by various types of mathematical formula, such as a linear equation, a second or higher order polynomial, an exponential function, or a logarithmic function. The form of the mathematical formula may be designated by the user before the machine learning. The coefficients are decided based on the training data by machine learning.

By using a model that has been learned, it is possible to predict the value of the objective variable (i.e., result) in an unknown case from the values of explanatory variables (i.e., factors) in the unknown case. As one example, it is possible to predict future demand of a product from a future weather forecast. The result predicted by the model may be a continuous value, such as a probability value in a range of 0 to 1 inclusive, or may be a discrete value such as the binary value “YES” or “NO”.

It is also possible to calculate the “prediction performance” of the learned model. The prediction performance is the ability to accurately predict the result of an unknown case, and is also referred to as the “precision”. The parallel distributed processing system samples data units that are included in the collected data but have not been used as the training data to produce test data, and calculates the prediction performance using the test data. As one example, the size of the test data is around half the size of the training data. The parallel distributed processing system inputs the values of the explanatory variables included in the test data into the model and compares the value of the objective variable (predicted value) outputted from the model and the value of the objective variable (actual value) included in the test data. Note that verifying the prediction performance of a learned model is sometimes referred to as “validation”.

Example indices of prediction performance include accuracy, precision, and root-mean-square error (RMSE). As one example, the result is expressed by the binary value “YES” or “NO”. Out of the N test data, the number of cases where the predicted value is “YES” and the actual value is “YES” is set as “Tp”, the number of cases where the predicted value is “YES” and the actual value is “NO” is set as “Fp”, the number of cases where the predicted value is “NO” and the actual value is “YES” is set as “Fn”, and the number of cases where the predicted value is “NO” and the actual value is “NO” is set as “Tn”. Here, the “accuracy” is the ratio of accurate predictions and is calculated as (Tp+Tn)/N. The “precision” is the probability that a prediction of “YES” is not erroneous and is calculated as Tp/(Tp+Fp). When the actual value in each case is expressed as y and the predicted value is expressed as “ŷ”, the RMSE is calculated as (sum(y−ŷ)²/N)^{1/2}.

Here, for a given machine learning algorithm, the larger the number of data units sampled as the training data (i.e., the larger the “sampling size”), the higher the prediction performance.

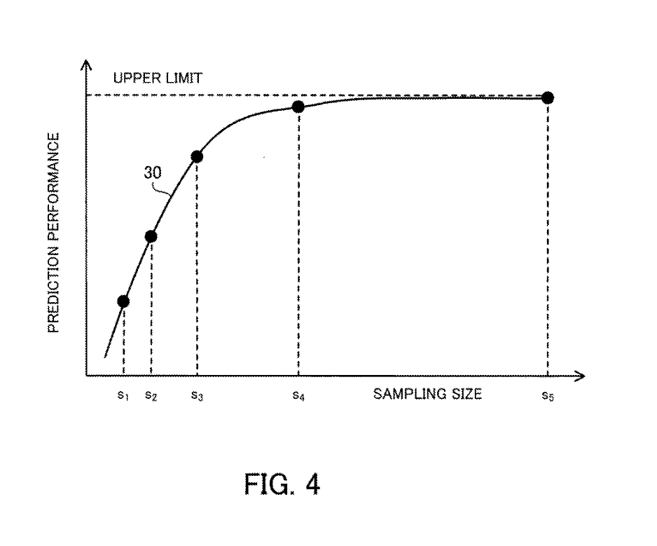

FIG. 4 is a graph depicting an example of the relationship between sampling size and prediction performance. The curve 30 depicts the relationship between the prediction performance of a model and the sampling size. The relative magnitudes of the sampling sizes s₁, s₂, s₃, s₄, and s₅ are such that s₁<s₂<s₃<s₄<s₅. As one example, s₂ is two or four times s₁, s₃ is two or four times s₂, s₄ is two or four times s₃, and s₅ is two or four times s₄.

As depicted by the curve 30, the prediction performance when the sampling size is s₂ is higher than for s₁. Likewise, the prediction performance when the sampling size is s3 is higher than for s₂, the prediction performance when the sampling size is s₄ is higher than for s₃, and the prediction performance when the sampling size is s₅ is higher than for s₄. In this way, the larger the sampling size, the higher the prediction performance. However, while the prediction performance is low, increases in the sampling size are accompanied by a large increase in prediction performance. On the other hand, there is an upper limit on prediction performance, and as the prediction performance approaches this upper limit, the ratio of the increase in prediction performance to the increase in sampling size decreases.

Also, the larger the sampling size, the greater the learning time taken by machine learning. This means that when the sampling size is excessively large, the machine learning becomes inefficient from the viewpoint of learning time. For the example in FIG. 4, when the sampling size is set at s₄, it is possible to reach a prediction performance that is close to the upper limit in a short time. On the other hand, when the sampling size is set at s₃, there is the risk of the prediction performance being insufficient. Also, when the sampling size is set at s₅, although the prediction performance is close to the upper limit, the increase in the prediction performance per unit learning time is small, which makes the machine learning inefficient.

The relationship between the sampling size and the prediction performance differs according to the properties (data type) of the data being used, even when the same machine learning algorithm is used. This means that it is difficult to estimate the smallest sampling size capable of achieving the upper limit of the prediction performance or a prediction performance close to the upper limit in advance before machine learning is performed. For this reason, progressive sampling is used.

With progressive sampling, the sampling size is gradually increased from an initial small value, and machine learning is repeated until the prediction performance satisfies a predetermined condition. As one example, the parallel distributed processing system performs machine learning with the sampling size s₁ and evaluates the prediction performance of the learned model. When the prediction performance is insufficient, the parallel distributed processing system performs machine learning with the sampling size s₂ and evaluates the prediction performance. At this time, the training data with the sampling size s₂ may incorporate part or all of the training data with the sampling size s₂ (i.e., the training data that was previously used). In the same way, the parallel distributed processing system performs machine learning with the sampling size s₃ and evaluates the prediction performance, and then performs machine learning with the sampling size s₄ and evaluates the prediction performance. When sufficient prediction performance is achieved with the sampling size s₄, the parallel distributed processing system stops the machine learning and adopts the model learned with the sampling size s₄. In this case, the parallel distributed processing system does not need to perform machine learning with the sampling size s₅.

As a stopping condition for the progressive sampling, as one example, it would be conceivable to set the difference (increase) in prediction performance between the immediately preceding model and the present model falling below a threshold as the stopping condition. It would also be conceivable to set the increase in prediction performance per unit learning time falling below a threshold as the stopping condition.

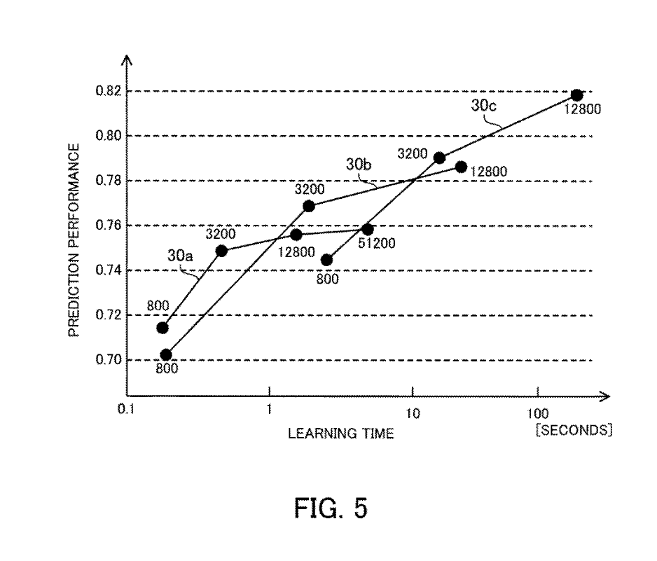

FIG. 5 is a graph depicting an example relationship between the learning time and the prediction performance. Curves 30a to 30c depict the relationship between the learning time measured using a famous dataset (“CoverType”) and the prediction performance. Accuracy is used here as the index of the prediction performance. The curve 30a depicts the relationship between the learning time and the prediction performance when logistic regression is used as the machine learning algorithm. The curve 30b depicts the relationship between the learning time and the prediction performance when Support Vector Machine is used as the machine learning algorithm. The curve 30c depicts the relationship between the learning time and the prediction performance when Random Forest is used as the machine learning algorithm. Note that the horizontal axis in FIG. 5 is learning time expressed using a logarithmic scale.

As depicted by the curve 30a, when logical regression is used, the prediction performance for a sampling size of 800 is around 0.71 and the learning time is around 0.2 seconds. The prediction performance for a sampling size of 3,200 is around 0.75 and the learning time is around 0.5 seconds. The prediction performance for a sampling size of 12,800 is around 0.755 and the learning time is around 1.5 seconds. The prediction performance for a sampling size of 51,200 is around 0.76 and the learning time is around 6 seconds.

As depicted by the curve 30b, when Support Vector Machine is used, the prediction performance for a sampling size of 800 is around 0.70 and the learning time is around 0.2 seconds. The prediction performance for a sampling size of 3,200 is around 0.77 and the learning time is around 2 seconds. The prediction performance for a sampling size of 12,800 is around 0.785 and the learning time is around 20 seconds.

As depicted by the curve 30c, when Random Forest is used, the prediction performance for a sampling size of 800 is around 0.74 and the learning time is around 2.5 seconds. The prediction performance for a sampling size of 3,200 is around 0.79 and the learning time is around 15 seconds. The prediction performance for a sampling size of 12,800 is around 0.82 and the learning time is around 200 seconds.

In this way, for the data set described above, logistic regression on the whole has a short learning time and a low prediction performance. Support Vector Machine on the whole has a longer learning time and a higher prediction performance than logistic regression. Random Forest on the whole has an even longer learning time and higher prediction performance than Support Vector Machine. However, in the example in FIG. 5, the prediction performance of Support Vector Machine when the sampling size is small is lower than the prediction performance of logistic regression. That is, the rising curve of prediction performance during an initial stage of progressive sampling differs according to the machine learning algorithm in use.

The upper limit of the prediction performance of each machine learning algorithm and the rising curve of the prediction performance also depend on the properties of the data in use. This means that out of a plurality of machine learning algorithms, it is difficult to specify in advance a machine learning algorithm for which the upper limit of the prediction performance is highest or a machine learning algorithm that is capable of achieving a prediction performance that is close to the upper limit in the shortest time. Accordingly, when progressive sampling is performed using a plurality of machine learning algorithms, it would be conceivable to use an arrangement where a model with high prediction performance is efficiently obtained. As one example, for an algorithm that is expected to have a large speed improvement in prediction performance, by preferentially proceeding with a model search with training data with a large data size, it is possible to use a model searching method where redundant model searches are avoided. In the following description, this method searching method is referred to as a “speed improvement-prioritizing search”.

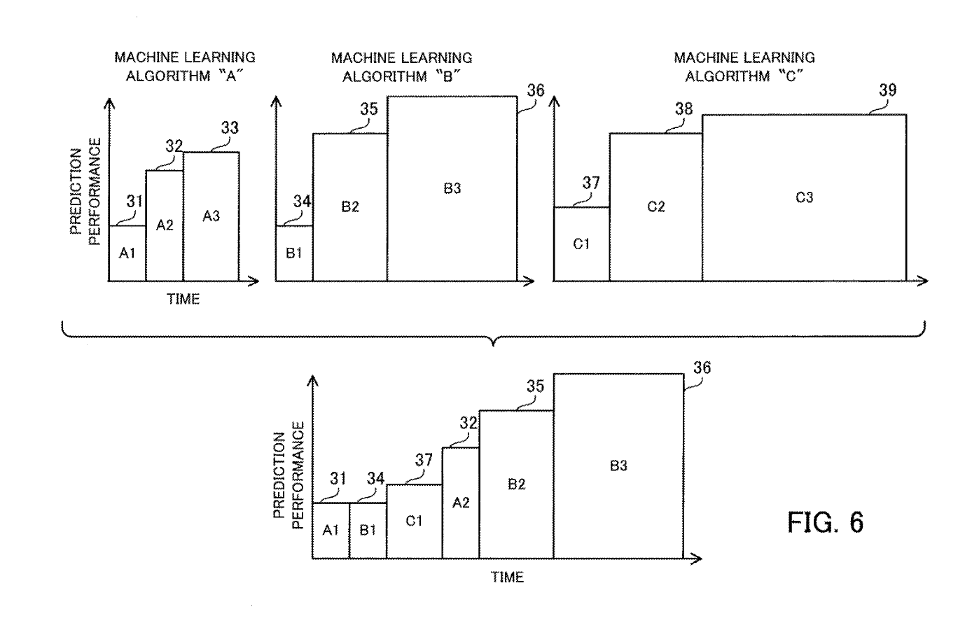

FIG. 6 depicts one example of the execution order when a speed improvement-prioritizing search is performed for a plurality of machine learning algorithms. The speed improvement-prioritizing search estimates, for each machine learning algorithm, the speed improvement in prediction performance achieved when a learning step with the next largest sampling size is executed, selects the machine learning algorithm with the largest speed improvement, and proceeds by only one learning step. Estimated values of the speed improvement are reviewed whenever the processing proceeds by one learning step. This means that in a speed improvement-prioritizing search, at first, learning steps of a plurality of machine learning algorithms are executed and the number of machine learning algorithms is gradually reduced.

The estimated value of the speed improvement is produced by dividing an estimated value of the performance improvement by an estimated value of the execution time. The estimated value of the performance improvement is the difference between the estimated value of the prediction performance of the next learning step and the highest value of the prediction performance that has been achieved so far by a plurality of machine learning algorithms (hereinafter referred to as the “achieved prediction performance”). The prediction performance of the next learning step is estimated based on the past prediction performance of the same machine learning algorithm and the sampling size of the next learning step. The estimated value of the execution time is the estimated value of the time taken by the next learning step, and is estimated based on the past execution time of the same machine learning algorithm and the sampling size of the next learning step.

The parallel distributed processing system executes a learning step 31 of the machine learning algorithm A, a learning step 34 of the machine learning algorithm B, and a learning step 37 of the machine learning algorithm C. The parallel distributed processing system estimates the speed improvement of each of the machine learning algorithms A, B, and C based on the execution results of the learning steps 31, 34, and 37. Here, it is assumed that the speed improvement of the machine learning algorithm A is estimated as 2.5, the speed improvement of the machine learning algorithm B as 2.0, and the speed improvement of the machine learning algorithm C as 1.0. The parallel distributed processing system accordingly selects the machine learning A that has the largest speed improvement and executes a learning step 32.

When the learning step 32 is executed, the parallel distributed processing system updates the speed improvements of the machine learning algorithms A, B, and C. Here, it is assumed that the speed improvement of the machine learning algorithm A is estimated as 0.73, the speed improvement of the machine learning algorithm B as 1.0, and the speed improvement of the machine learning algorithm C as 0.5. Since the achieved prediction performance has increased due to the learning step 32, the speed improvements of the machine learning algorithms B and C also fall. The parallel distributed processing system selects the machine learning algorithm B with the largest speed improvement and executes the learning step 35.

When the learning step 35 has been executed, the parallel distributed processing system updates the speed improvements of the machine learning algorithms A, B, and C. Here, it is assumed that the speed improvement of the machine learning algorithm A is 0.0, the speed improvement of the machine learning algorithm B is 0.8, and the speed improvement of the machine learning algorithm C is 0.0. The parallel distributed processing system selects the machine learning algorithm B with the largest speed improvement and executes the learning step 36. When it is determined that the prediction performance has been sufficiently increased by the learning step 36, the machine learning ends. In this case, the learning step 33 of the machine learning algorithm A and the learning steps 38 and 39 of the machine learning algorithm C are not executed.

Note that when estimating the prediction performance of the next learning step, it is preferable to consider statistical errors to reduce the risk of quickly excluding machine learning algorithms where there is the possibility of the prediction performance subsequently rising. As one example, it would be conceivable for the parallel distributed processing system to calculate an expected value of the prediction performance by regression analysis and also the 95% prediction interval, and to use the upper limit of the 95% prediction interval (UCB: Upper Confidence Bound) as the estimated value of the prediction performance when calculating the speed improvement. The 95% prediction interval indicates the fluctuation in the prediction performance to be measured (or “measured value”) and indicates that the new prediction performance is predicted to be within this interval with a 95% probability. That is, a value that is larger than the statistically expected value by a margin which considers the statistical error is used.

However, in place of UCB, the parallel distributed processing system may integrate the distribution of the estimated prediction performance to calculate a probability (or “PI”: Probability of Improvement) that the prediction performance will exceed the achieved prediction performance. The parallel distributed processing system may also integrate the distribution of the estimated prediction performance to calculate an expected value (or “EI”: Expected Improvement) by which the prediction performance exceeds the achieved prediction performance.

In a speed improvement-prioritizing search, learning steps that do not contribute to an improvement in prediction performance are not executed, which makes it possible to reduce the overall learning time. Also, learning steps of machine learning algorithms with the highest improvement in performance per unit time are preferentially executed. This means that even when there is a limit on the learning time and machine learning is stopped midway, the model obtained by the end time will be the best model obtained within the limit time. Also, although there is the possibility of learning steps that contribute even just a little to prediction performance being placed toward the end of the execution order, there is still some chance of these steps being executed. This means that it is possible to reduce the risk of a machine learning algorithm with a high upper limit on the prediction performance being cut off.

In this way, a speed improvement-prioritizing search is effective in reducing the learning time. However, due to the execution order of the model search, a speed improvement-prioritizing search is inefficient with regard to reuse of cached training data.

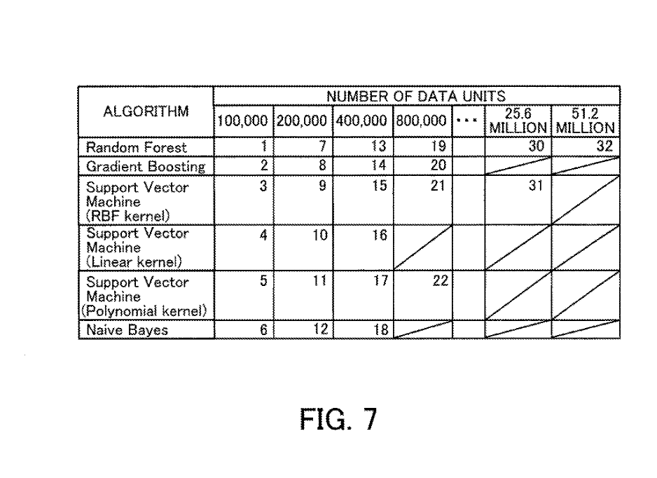

FIG. 7 depicts a first example of an execution order of model searches. In the example depicted in FIG. 7, the number of data units in the original data is 60 million, and the size of the initial training data is set at 100,000. Here, machine learning is executed so that whenever processing proceeds by one learning step, the sampling rate is doubled. The numeric values in the table depicted in FIG. 7 indicate the execution order in which a model search that uses training data with the number of data units given in the column in which the numeric value is placed is performed by the machine learning algorithm indicated in the row in which the numeric value is placed.

In the example in FIG. 7, after training data produced by sampling 100,000 data units has first been generated, the training data is cached when executing machine learning according to the machine learning algorithm “Random Forest”. When a model search is executed by subsequent machine learning algorithms, the cached training data is reused. When the seventh position in the execution order is reached, since training data composed of 200,000 data units has not been cached, training data is newly generated and cached. After this, the training data composed of 200,000 data units is reused when executing the eighth and subsequent model searches.

In this way, whenever training data is generated, by successively performing a plurality of model searches according to different machine learning algorithms using the same training data, it is possible to effectively reuse the cached training data. On the other hand, when a speed improvement-prioritizing search is performed, there is no guarantee that training data with the same sampling rate will be consecutively used.

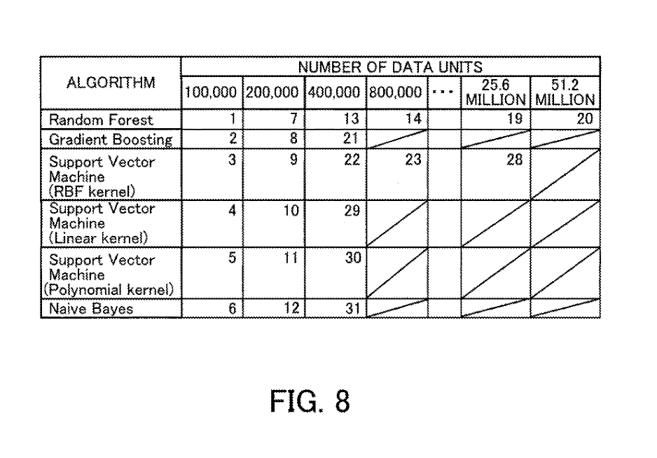

FIG. 8 depicts a second example of an execution order of model searches. FIG. 8 depicts the execution order when model searches are performed according to a speed improvement-prioritizing search. In the example in FIG. 8, models are first generated according to various machine learning algorithms using training data composed of 100,000 and 200,000 data units, and the prediction performance of the respective models is evaluated. After this, based on the predicted speed improvement of the model that will be generated by the next model search to be executed by each machine learning algorithm, the combination of training data and machine learning algorithm to be used in the next model search is decided. In the example in FIG. 8, when execution has been completed using the training data with 200,000 data units, a model search performed according to the machine learning algorithm “Random Forest” using training data composed of 400,000 data units is estimated to have the highest predicted speed improvement. In the following steps also, the machine learning algorithm “Random Forest” continues to have the highest predicted speed improvement. Accordingly, model searches according to the machine learning algorithm “Random Forest” are executed consecutively until the number of data units in the training data reaches 51.2 million, and the prediction performance of the generated models is evaluated. After this, the prediction performance of a model generated by the machine learning algorithm “Gradient Boosting” that uses training data composed of 400,000 data units is evaluated.

When considering reuse of the training data, it would be ideal to cache training data for all of the sampling rates. However, as depicted in FIG. 8, when a speed improvement-prioritizing search is executed, the prediction performance of model searches according to the machine learning algorithm “Random Forest” are evaluated before other machine learning algorithms. As a result, sets of training data with high sampling rates are generated and cached. In this example, 100,000+200,000+400,000+ . . . +51.2 million=102.4 million data units are cached. Caching all of the training data would take a storage capacity of around double the size of the original data (60 million). On top of this, the original data is cached so that training data of the respective sampling rates is efficiently generated.

Since in reality there is a limit on the amount of data that is cached, when the total amount of data with each sampling rate that has been generated exceeds the amount of data that can be cached, some of the training data is deleted from the cache.

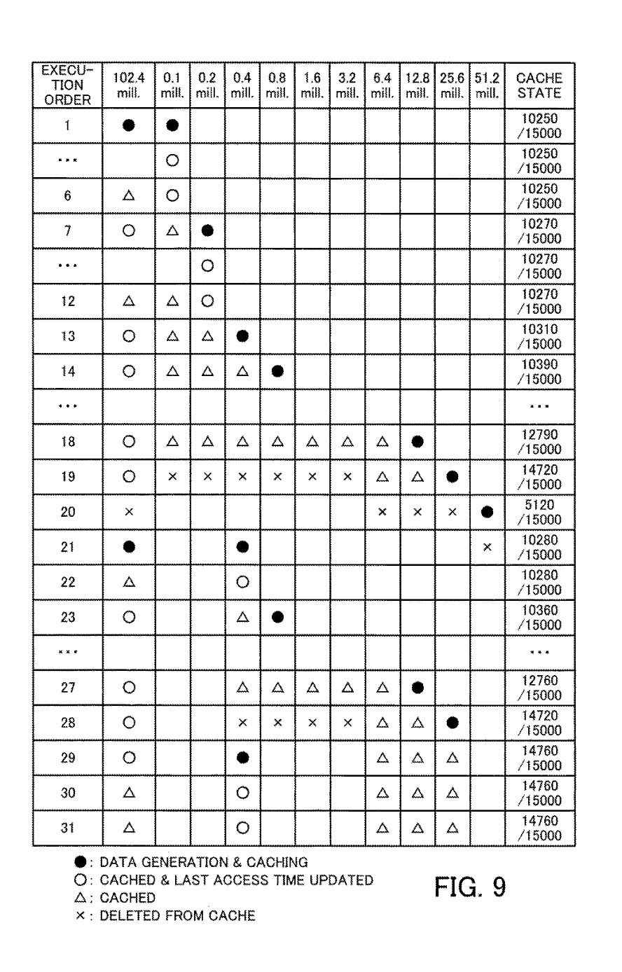

As one example, assume that a model search is performed for 102.4 million units of input data in an environment where the total amount of data that can be cached is 150 million data units. Here, as one example, consider a case where cached training data is deleted according to an LRU policy. When sampling commences with 100,000 data units and the amount of data doubles every time the processing advances by one learning step, the state of the cache will be as depicted in FIG. 9.

FIG. 9 depicts an example of transitions in the cache state when an LRU policy is used. In the table depicted in FIG. 9, the operation content and cache state are depicted for the original data and training data of various sampling rates when model searches are executed in the order given in the “Execution Order” column. In the column where the number of data units is “102.4 million (mill.)”, the operation content for the original data is given. In the columns where the number of data units is “100,000 (0.1 mill.)” to “51.2 million”, operation contents for training data are given. In the “cache state” column, transitions in the amount of data being cached are given.

The content of operations performed on the training data is expressed by symbols provided at positions where the training data is operated. Symbols in the form of black circles indicate the execution of generation and cache processing of the data. Symbols in the form of white circles indicate that the data is cached and that the last access time of data has been updated. The triangular symbols indicate that the data is cached and that the last access time has not been updated. The cross symbols indicate deletion from the cache. The cache state is indicated by the total number of data units included in the cached training data.

Note that since data with a new sampling rate is generated from the original data in the cache, the last access time of the original data is also updated whenever new data is generated. In the example in FIG. 9, at position “19” in the execution order, the cache capacity is insufficient to newly cache the training data with 25.6 million data units. For this reason, deletion of the training data with the oldest last access time occurs in keeping with the LRU policy. In addition, when executing the 20^{th} step that follows, unless the original data is deleted, it is not possible to cache the 51.2 million data units that compose the training data. However, the cached 51.2 million data units that compose the training data will not be reused. Also, although the training data composed of 400,000 data units is used in the 21^{st} step, this training data will have been deleted from the cache when the 19^{th} step was executed, resulting in this training data being regenerated. In addition, since the original data was also deleted from the cache when the 20^{th} step was executed, the original data also needs to be loaded from a storage apparatus. As a result, the efficiency with which data is reused falls compared to an arrangement where a plurality of model searches are consecutively executed, whenever training data is generated, by different machine learning algorithms using the same training data.

The cause of this problem is the use of LRU as the cache policy. According to an LRU policy, it is assumed that data for which caching is valid is accessed frequently and data is deleted in order starting from data with the oldest access time. However, with a speed improvement-prioritizing search, an algorithm predicted to have a large performance improvement is preferentially executed, and when the same algorithm is continuously determined to be effective, training data with a different sampling rate to the previous execution is used every time. As a result, when an attempt is made to reuse training data with a low sampling rate, there are cases where the training data will have already been deleted from the cache.

In addition, although a promising machine learning algorithm will be executed using training data with a high sampling rate, many machine learning algorithms with lower expectations only get to use training data with a low sampling rate. As a result, the possibility that training data with a high sampling rate will be reused is low. However, when an LRU policy is employed, irrespective of the above situation, when training data with a high sampling rate has been used, the training data with the high sampling rate will be cached regardless of whether this training data will actually be used in the future. The training data with the high sampling rate has a large amount of data, and when there is no actual possibility of this training data being used, it means that wasteful use will be made of memory resources.

For this reason, with the parallel distributed processing system according to the second embodiment, a cache algorithm that uses estimated values of the prediction performance is used as the cache policy when a speed improvement-prioritizing search is performed during the machine learning.

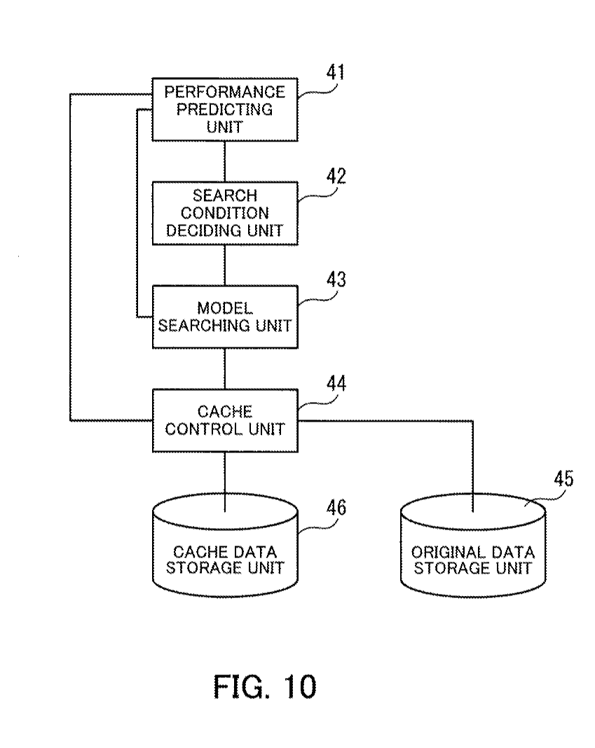

FIG. 10 is a block diagram depicting a machine learning function of the parallel distributed processing system according to the second embodiment. The parallel distributed processing system includes a performance predicting unit 41, a search condition deciding unit 42, a model searching unit 43, a cache control unit 44, an original data storage unit 45, and a cache data storage unit 46.

The performance predicting unit 41 predicts, for each machine learning algorithm, the performance in each learning step that has a possibility of being subsequently performed based on the evaluation result of the prediction performance of several steps in the past. The performance predicting unit 41 then calculates the speed improvement in prediction performance.

The search condition deciding unit 42 decides the conditions (or “search conditions”) of the model search to be executed next. The search conditions include an identifier of the machine learning algorithm to be used, the sampling rate of the training data to be used, and the like. As one example, the search condition deciding unit 42 compares, for each machine learning algorithm, the speed improvement in prediction performance in the next learning step and decides to use the machine learning algorithm with the highest speed improvement in prediction performance as the algorithm to be used for the next model search.

The model searching unit 43 executes a model search in accordance with the decided search conditions. In the model search, generation of a model using the training data and evaluation of the prediction performance of the generated model are performed. The model searching unit 43 acquires data to be used in the model search from the original data storage unit 45 or the cache data storage unit 46 via the cache control unit 44. When new training data has been generated based on the original data, the model searching unit 43 transmits the training data to the cache control unit 44.

The cache control unit 44 reads data to be used by the model searching unit 43 from the original data storage unit 45 or the cache data storage unit 46 and transmits to the model searching unit 43. The cache control unit 44 determines whether to cache the training data acquired from the model searching unit 43 based on the speed improvement in prediction performance of unexecuted learning steps of each machine learning algorithm. On deciding to cache the training data, the cache control unit 44 stores the training data in the cache data storage unit 46. When the free space in the cache data storage unit 46 is insufficient, the cache control unit 44 decides which data is to be deleted based on the speed improvement in prediction performance of the unexecuted learning steps of each machine learning algorithm and deletes the decided data from the cache data storage unit 46.

The original data storage unit 45 stores the original data for performing machine learning. Out of the training data generated by sampling and extracting data units from the original data, the cache data storage unit 46 stores the training data for which caching has been decided. The storage capacity of the cache data storage unit 46 may also be referred to as the “cache capacity”. The cache data storage unit 46 is accessed at higher speed than the original data storage unit 45. As one example, the original data storage unit 45 is provided in a storage apparatus such as an HDD and the cache data storage unit 46 is provided in a memory.

Each element depicted in FIG. 10 is realized by distributed processing by the master node 100 and the plurality of worker nodes 210, 220, . . . depicted in FIG. 2. As one example, the performance predicting unit 41 and the search condition deciding unit 42 are provided inside the master node 100. The model searching unit 43, the cache control unit 44, the original data storage unit 45, and the cache data storage unit 46 are realized by distributed processing by the plurality of worker nodes 210, 220, . . . .

Note that the lines that join the respective elements depicted in FIG. 10 depict only some of the communication paths and it is also possible to set other communication paths aside from the illustrated communication paths. As another example, the functions of the elements depicted in FIG. 10 can be realized by having a computer execute program modules corresponding to the elements.

Next, an overview of cache processing for data will be described.

In the second embodiment, first, a model search is performed for each of a plurality of machine learning algorithms using several steps' worth of training data with low sampling rates. By doing so, it is possible to calculate a speed improvement in prediction performance of each machine learning algorithm.

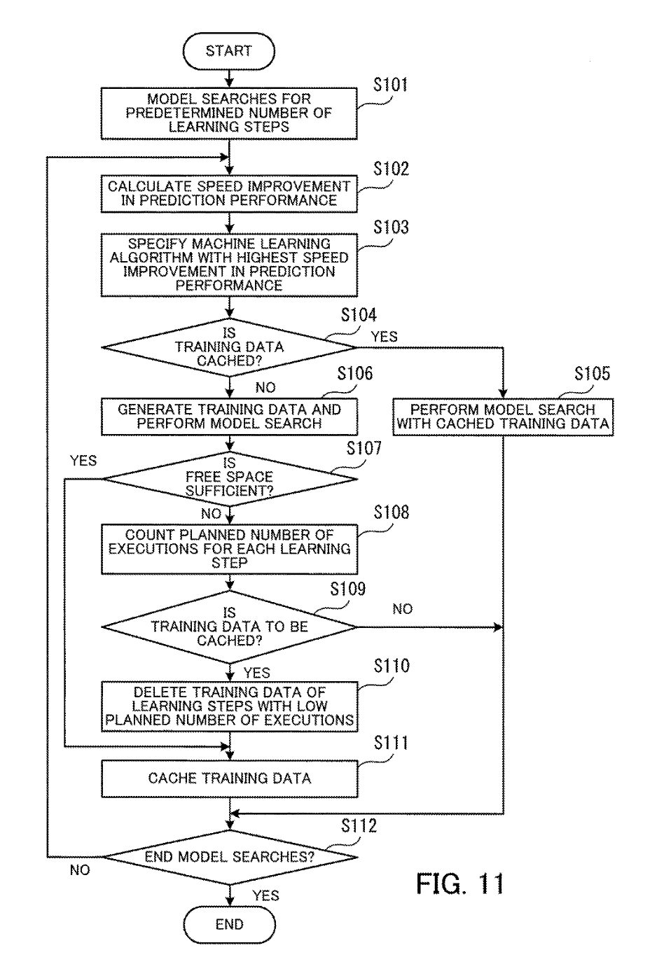

FIG. 11 is a flowchart depicting the overall procedure of machine learning. The processing depicted in FIG. 11 is described below in order of the step numbers.

[Step S101] The model searching unit 43 performs model searches for a predetermined number of learning steps for every machine learning algorithm in accordance with search conditions successively decided by the search condition deciding unit 42. The model searching unit 43 then transmits an evaluation result of the performance obtained by the model search to the performance predicting unit 41.

[Step S102] The performance predicting unit 41 finds, for each machine learning algorithm, the speed improvement in prediction performance when unexecuted learning steps are executed.

[Step S103] The search condition deciding unit 42 decides on a machine learning algorithm with the highest speed improvement in prediction performance for the learning step scheduled to be executed next as the next machine learning algorithm to be executed. The search condition deciding unit 42 also investigates the learning step to be executed next for the specified machine learning algorithm. The search condition deciding unit 42 then transmits search conditions which include an identifier of the specified machine learning algorithm and a sampling rate of the training data to be used in the next learning step, to the model searching unit 43.

[Step S104] The model searching unit 43 transmits an acquisition request for training data with the designated sampling rate to the cache control unit 44. The cache control unit 44 then determines whether the training data indicated by the acquisition request is being cached by the cache data storage unit 46. When the data is being cached, the processing proceeds to step S105. When the data is not being cached, the processing proceeds to step S106.

[Step S105] The model searching unit 43 acquires training data with the designated sampling rate from the cache data storage unit 46 and performs a model search according to the machine learning algorithm indicated in the search request. After this, the processing proceeds to step S112.

[Step S106] The model searching unit 43 performs sampling of data units from the original data at the designated sampling rate to generate training data. The model searching unit 43 then uses the generated training data to perform a model search according to the machine learning algorithm indicated in the search request.

[Step S107] The cache control unit 44 determines whether the free space in the cache data storage unit 46 is sufficient. As one example, the cache control unit 44 sets a value produced by subtracting the number of data units already stored in the cache data storage unit 46 from the number of data units that can be stored in the cache data storage unit 46 as the free space. The cache control unit 44 determines that the free space is sufficient when the free space is equal to or greater than the data size of the generated training data. When the free space is sufficient, the processing proceeds to step S111. When the free space is not sufficient, the processing proceeds to step S108.

[Step S108] The cache control unit 44 investigates, for each learning step Sᵢ, the number of algorithms for which the speed improvement in prediction performance is greater than a threshold K (where K is a positive real number), and sets the result as the planned number of executions Tᵢ. Here, i is an integer that is one or higher, and the expression “learning step Sᵢ” indicates the i^{th} learning step in order starting from the learning step with the lowest sampling rate. The planned number of executions Tᵢ is also the caching priority of the training data used in the corresponding learning step Sᵢ.

The threshold K may be given in advance as a static value before the start of the model search or may be dynamically decided in accordance with a certain conditional expression. Also, when it is desirable to apply a weighting to data with a high sampling rate, a threshold Kᵢ may be assigned to each learning step so as to decrease as the value of i increases. Note that by defining a planned number of executions Tₒ corresponding to the original data, it is possible to manage the cached original data in the same way as the training data. In this case, the cache control unit 44 sets the value of the planned number of executions Tₒ of the original data at infinity.

[Step S109] The cache control unit 44 determines whether to cache the generated training data. As one example, the cache control unit 44 arranges the learning steps that use training data that is already cached and the learning steps that use training data that has been generated by the present model search into descending order of the planned number of executions. The cache control unit 44 determines to cache the training data when a total produced by adding the data size of the training data used in higher-order learning steps than the learning steps that use the generated training data and the data size of the generated training data is equal to or below the cache capacity. When the generated training data is to be cached, the processing proceeds to step S110. When the generated training data is not to be cached, the processing proceeds to step S112.

[Step S110] The cache control unit 44 deletes training data from the cache data storage unit 46 with priority given to training data of learning steps for which the planned number of executions is low. As one example, the cache control unit 44 deletes the cached training data until the free space in the cache data storage unit 46 is equal to or above the number of data units in the generated training data.

[Step S111] The cache control unit 44 caches the generated training data. That is, the cache control unit 44 stores the generated training data in the cache data storage unit 46.

[Step S112] The model searching unit 43 determines whether the end condition for model searches is satisfied. As one example, the improvement in the prediction performance achieved by a generated model becoming equal to or falling below a certain value is set as the end condition for model searches. When the end condition is satisfied, the model for which the highest prediction performance has been obtained so far is outputted as the learning result and the machine learning process ends. When the end condition is not satisfied, the processing proceeds to step S102.

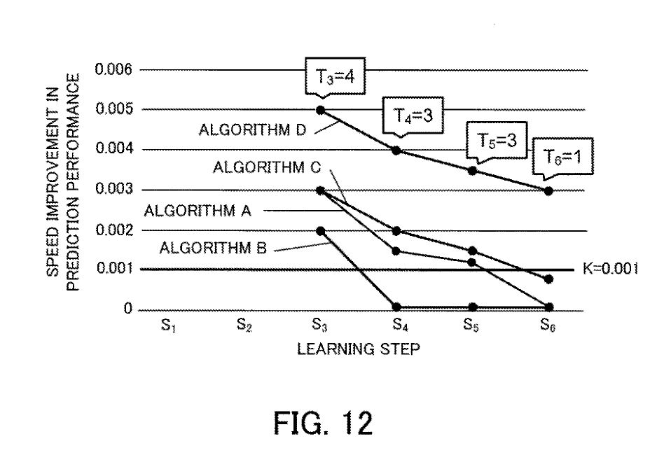

Machine learning proceeds according to this procedure so that efficient cache control is performed. Next, an example calculation of the planned number of executions of each learning step will be described with reference to FIGS. 12 to 15. Note that in the examples in FIGS. 12 to 15, it is assumed that machine learning is performed using four machine learning algorithms named “Algorithm A” to “Algorithm D”.

FIG. 12 depicts a first example of the planned number of executions of each learning step. In the example in FIG. 12, the horizontal axis depicts learning steps and the vertical axis depicts the speed improvement in prediction performance. The threshold K is “0.001”. FIG. 12 depicts the speed improvement in prediction performance that is calculated after model searches in the learning step S₁ and the learning step S₂ have been performed according to every machine learning algorithm.

In the learning step S₃, the speed improvement in prediction performance is equal to or above the threshold K for all four machine learning algorithms. Accordingly, the planned number of executions T₃ is “4”. In the learning step S₄, the speed improvement in prediction performance is equal to or above the threshold K for three of the machine learning algorithms. Accordingly, the planned number of executions T₄ is “3”. In the learning step S₅, the speed improvement in prediction performance is equal to or above the threshold K for three of the machine learning algorithms. Accordingly, the planned number of executions T₅ is “3”. In the learning step S₆, the speed improvement in prediction performance is equal to or above the threshold K for only one of the machine learning algorithms. Accordingly, the planned number of executions T₆ is “1”.

According to a speed improvement-prioritizing search, model searches are executed in descending order of the speed improvement in prediction performance. In the example in FIG. 12, model searches in the learning steps S₃, S₄, S₅, and S₆ according to “Algorithm D” are executed before the other machine learning algorithms.

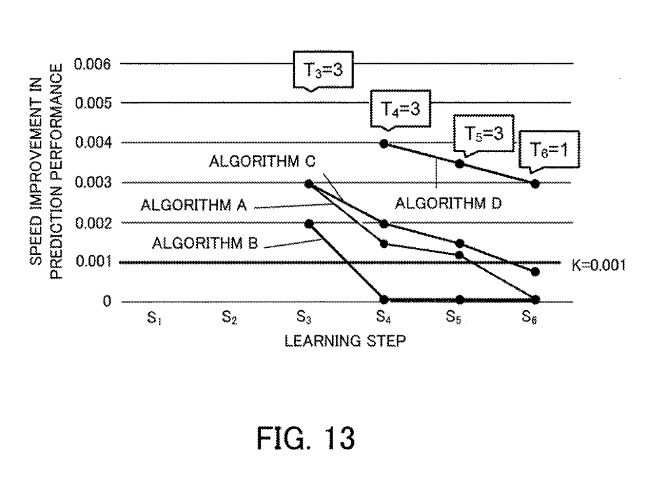

FIG. 13 depicts a second example of the planned number of executions of each learning step. FIG. 13 depicts the calculation results of the planned number of executions after execution of a model search in the learning step S₃ according to “Algorithm D”. Compared to FIG. 12, the planned number of executions T₃ is changed to “3”.

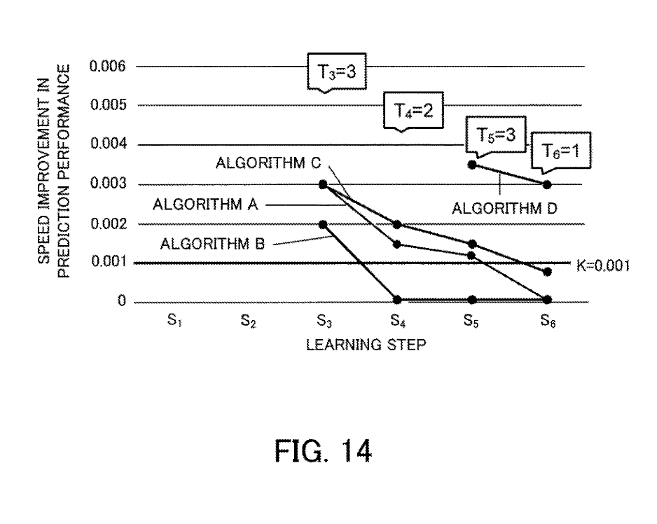

FIG. 14 depicts a third example of the planned number of executions of each learning step. FIG. 14 depicts the calculation results of the planned number of executions after execution of a model search in the learning step S₄ according to “Algorithm D”. Compared to FIG. 13, the planned number of executions T₄ is changed to “2”.

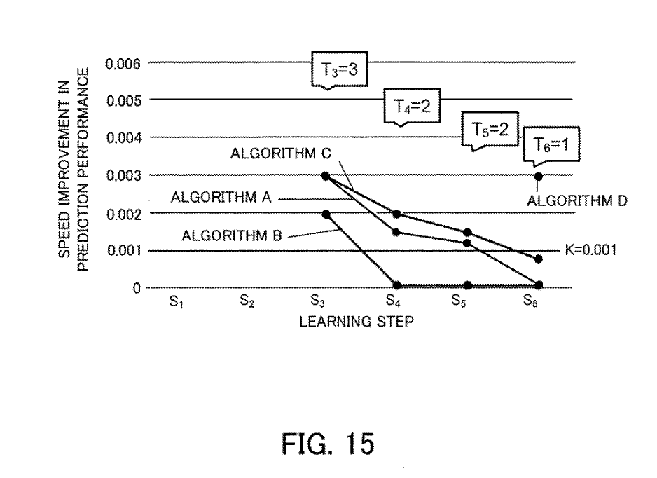

FIG. 15 depicts a fourth example of the planned number of executions of each learning step. FIG. 15 depicts the calculation results of planned number of executions after execution of a model search in the learning step S₅ according to “Algorithm D”. Compared to FIG. 14, the planned number of executions T₅ is changed to “2”.

In this way, the planned number of executions is recalculated every time the model search progresses, so that the planned number of executions Tᵢ changes in each learning step.

Next, as one example, a model search in the learning step S₆ according to “Algorithm D” is executed. It is assumed that at this time, the free space is insufficient for caching the training data used in the model search in the learning step S₆. Here, when data that has been cached is deleted according to an LRU policy, as one example, the training data used in the model search in the learning step S₃ would be deleted. The planned number of executions T₃ of the learning step S₃ is “3”. This means that when the training data used in the model search in the learning step S₃ is deleted, training data would be regenerated when the model search in the learning step S₃ is executed according to another machine learning algorithm, which makes the processing inefficient.

On the other hand, with the second embodiment, the training data of learning steps for which the planned number of executions is low is not cached. In the example in FIG. 15, after a model search in the learning step S₆ according to “Algorithm D” has been executed, the training data that was used in the model search is not used again. That is, the planned number of executions T₆ is “0”. As a result, the decision is taken to not cache the training data used in the model search in the learning step S₆.

In this way, when the importance of caching data, even training data that has just been newly generated, is low, the training data in question is not cached and other training data is kept in the cache. This means that it is possible to reuse the cached training data when executing a model search in the learning step S₃ of “Algorithm A” and the learning step S₃ of “Algorithm C”, for example. As a result, the process of generating training data is omitted, which improves the processing efficiency.

Also, by setting the value of the planned number of executions T corresponding to the original data used to generate the data in each step at infinity, it is possible to prevent the original data from being deleted from the cache. Since the original data is a large amount of data, by caching the original data in a memory, it is possible to rapidly extract data units from the original data when sampling data.

Note that with the cache policy indicated in the second embodiment, the more accurately the speed improvement in prediction performance of each learning step is estimated, the higher the caching efficiency that is realized. In the second embodiment, before a model search in the learning step Sᵢ is executed, model searches up to the learning step Sᵢ₋₁ have been executed, and the learning time taken by execution and the prediction performance of each model are known. For this reason, as depicted in FIG. 5, the performance predicting unit 41 calculates an expression that expresses a curve indicating the relationship between the learning time and the prediction performance for each machine learning algorithm. This enables the performance predicting unit 41 to accurately estimate the prediction performance of each subsequent learning step in each machine learning algorithm based on the calculated expression. As a result, it is possible to accurately estimate the speed improvement in prediction performance and possible to accurately determine whether to cache training data.

Note that although a situation where the training data is deleted from the cache region when the cache capacity is insufficient has been described above, it is also possible to save the training data deleted from the cache in another large-capacity storage apparatus, such as an SSD or an HDD.

Also, although in the above description, the number of algorithms for which the predicted speed improvement is larger than the threshold K is set at the planned number of executions and it is determined whether to cache training data based on the planned number of executions, it is also possible to add weightings to the planned numbers of executions according to the amount of data in each set of training data. As one example, the weighting is larger the larger the amount of data. By doing so, when the planned number of executions is equal for a plurality of learning steps, out of the training data of these learning steps, training data composed of a large amount of data is cached with priority. Since training data composed of a large amount of data takes a longer time to generate, storing this data with priority in a cache to enable reuse makes it possible to improve the processing efficiency.

Also, in the second embodiment, although memory resources used as a cache are assigned to training data so that memory resources are assigned in order starting with training data of learning steps with the highest planned number of executions, it is also possible to decide the amount of memory resources to be assigned based on the planned number of executions. As one example, consider a case where there are a learning step (or “first learning step”) for which the planned number of executions is “3” and a learning step (or “second learning step”) for which the planned number of executions is “2”. Here, as one example, the cache control unit 44 calculates a value produced by subtracting one from the planned number of executions of the first learning step and the second learning step. Since it is unnecessary to cache training data after a model search when the planned number of executions is one, the number of times it will be effective to cache training data after use in a model search is one less than the planned number of executions. The cache control unit 44 then proportionally distributes the entire cache capacity in accordance with the values produced by subtracting “1” from the planned numbers of executions. As one example, the entire cache capacity is distributed at a ratio of 2:1 to the first learning step and the second learning step.

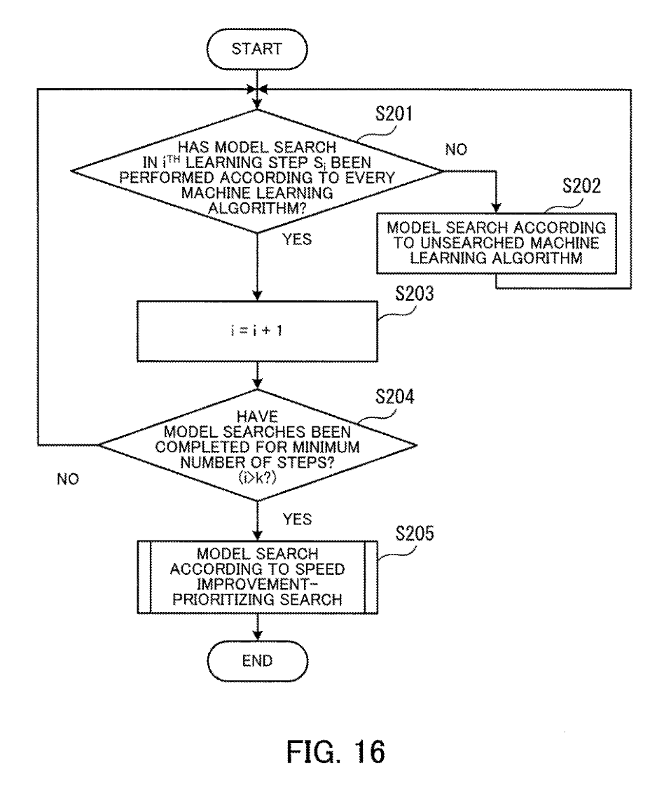

Next, the procedure of machine learning will be described in detail with reference to FIGS. 16 to 18. Note that the variables used in the processing depicted in FIGS. 16 to 18 are as follows.

N: Total number of learning steps (an integer of 1 or higher)

i: Order in which a learning step is executed (where 1≦i≦N)

k: minimum number of learning steps for calculating speed improvement in prediction performance (or “minimum number of steps”)

dᵢ: training data generated in the i^{th} learning step Sᵢ

s₁: size of the training data generated in the learning step Sᵢ

Aⱼ: j^{th} machine learning algorithm (where j is an integer of 1 or higher)

Pᵢ(Aⱼ): speed improvement in prediction performance predicted for when a model search is executed using the machine learning algorithm Aⱼ in the learning step Sᵢ

K: threshold of speed improvement in prediction performance

T₁: planned number of executions in the learning step Sᵢ (number of yet-to-be-executed machine learning algorithms for which the speed improvement in prediction performance is greater than the threshold K)

F(i): a flag indicating whether to cache the training data generated in the learning step Sᵢ, which is set at “true” when the data is to be cached and at “false” when the data is not to be cached.

C(i): a flag indicating whether the training data generated in the learning step Sᵢ has already been cached, which is set at “true” when the data is cached and at “false” when the data is not cached.

sₒ: size of the original data

FIG. 16 is a flowchart depicting the detailed procedure of the machine learning. The processing depicted in FIG. 16 will now be described in order of the step numbers. Note that each learning step is assigned a number which indicates an order, in ascending order of the sampling rate. When a machine learning instruction has been inputted, execution of the processing depicted in FIG. 16 is started with the initial value of the variable i at “1”.

[Step S201] The model searching unit 43 uses the training data of the i^{th} learning step Sᵢ to determine whether a model search has been performed according to every machine learning algorithm. When there is a machine learning algorithm that is yet to be executed, the processing proceeds to step S202. When a model search has been completed for every machine learning algorithm, the processing proceeds to step S203.

[Step S202] The search condition deciding unit 42 selects one machine learning algorithm for which a model search that uses the training data of the i^{th} learning step Sᵢ has not been performed. The search condition deciding unit 42 then transmits a search condition, which indicates a model search of the i^{th} learning step Sᵢ according to the selected machine learning algorithm, to the model searching unit 43. The model searching unit 43 performs a model search according to the received search condition. After this, the processing proceeds to step S201.

[Step S203] The search condition deciding unit 42 adds one to the value of the variable i.

[Step S204] The search condition deciding unit determines whether model searches by the minimum number of learning steps have been completed for every machine learning algorithm. For example, when “i>k” is satisfied, it is determined that model searches by the minimum number of learning steps have been completed. When the condition is satisfied, the processing proceeds to step S205. When the condition is not satisfied, the processing proceeds to step S201.

[Step S205] The performance predicting unit 41, the search condition deciding unit 42, the model searching unit 43, and the cache control unit 44 operate in concert to execute a model searching process according to a speed improvement-prioritizing search.

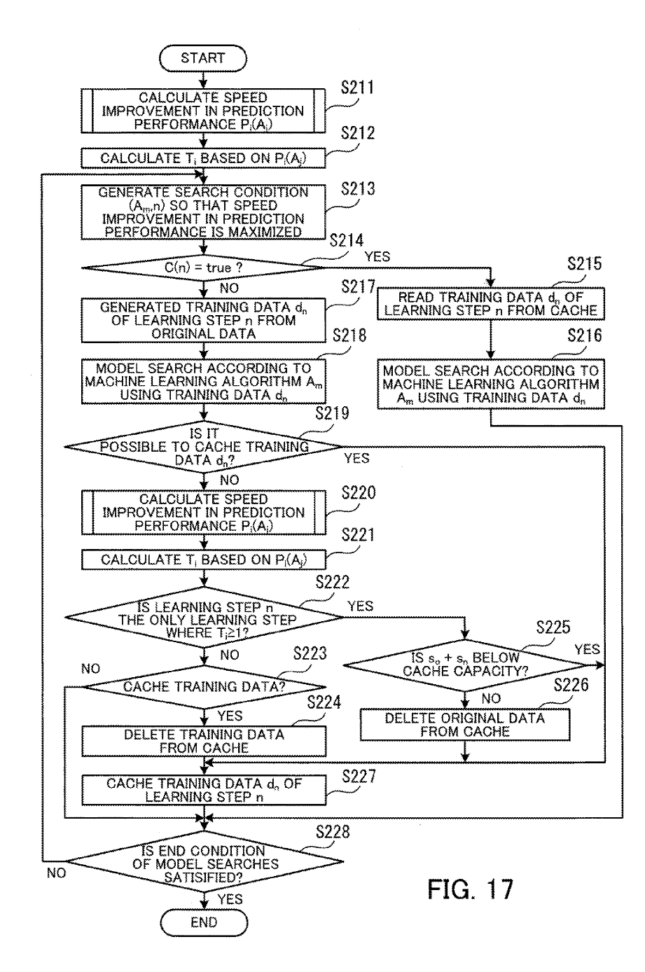

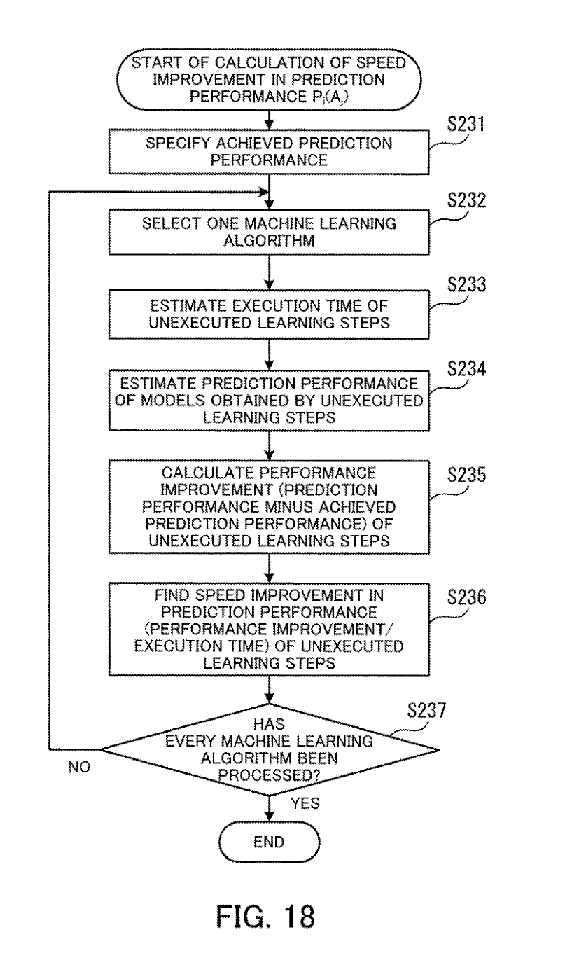

FIG. 17 is a flowchart depicting the procedure of the model searching process according to a speed improvement-prioritizing search. The processing depicted in FIG. 17 will now be described in order of the step numbers.

[Step S211] The performance predicting unit 41 calculates the speed improvement in prediction performance Pᵢ(Aⱼ) produced by a model search that is yet to be performed. This processing is described in detail later (see FIG. 18).

[Step S212] The performance predicting unit 41 calculates the planned number of executions Tᵢ for each learning step based on the speed improvement in prediction performance Pᵢ(Aⱼ). The calculation method is as was described earlier with reference to FIGS. 12 to 15.

[Step S213] The search condition deciding unit 42 generates a search condition “Aⱼ, n” so that the speed improvement in prediction performance is maximized. Here, Aₘ is the m^{th} machine learning algorithm (where m is an integer of 1 or higher) and n indicates the order of the learning step with the lowest sampling rate out of the learning steps that are yet to be executed for that machine learning algorithm. As one example, the search condition deciding unit 42 specifies the learning step with the lowest sampling rate out of the learning steps yet to be executed for each machine learning algorithm. Next, the search condition deciding unit 42 detects the machine learning algorithm with the highest speed improvement in prediction performance Pᵢ(Aⱼ) out of the learning steps specified for each machine learning algorithm. The search condition deciding unit 42 then generates a search condition (Aₘ, n) that designates the detected machine learning algorithm and the learning step with the lowest sampling rate out of the learning steps yet to be executed for that machine learning algorithm.

The search condition deciding unit 42 transmits the generated search condition to the model searching unit 43. The model searching unit 43 requests the cache control unit 44 for the training data dₙ used in the learning step n designated by the search condition.

[Step S214] The cache control unit 44 determines whether the training data dₙ used in the learning step n designated by the search condition is already cached. As one example, the cache control unit 44 determines that the training data dₙ is already cached when “C(n)=true”. When the data is already cached, the processing proceeds to step S215. When the data is not cached, the processing proceeds to step S217.

[Step S215] The model searching unit 43 reads the training data dₙ used in the learning step n from the cache. As one example, the model searching unit 43 reads the training data dₙ that is used in the learning step n via the cache control unit 44 from the cache data storage unit 46.

[Step S216] The model searching unit 43 uses the training data dₙ used in the learning step n to execute a model search according to the machine learning algorithm Aₘ. After this, the processing proceeds to step S228.

[Step S217] The model searching unit 43 generates the training data dₙ to be used in the learning step n from the original data. As one example, the model searching unit 43 requests the cache control unit 44 for the original data. When the original data is stored in the cache data storage unit 46, the cache control unit reads the original data from the cache data storage unit 46 and transmits the original data to the model searching unit 43. When the original data is not stored in the cache data storage unit 46, the cache control unit 44 reads the original data from the original data storage unit 45 and transmits the original data to the model searching unit 43. The model searching unit 43 then samples data units from the original data received from the cache control unit 44 to generate the training data dₙ.

[Step S218] The model searching unit 43 uses the training data dₙ used in the learning step n to execute a model search according to the machine learning algorithm Aₘ.

[Step S219] The cache control unit 44 determines whether it is possible to cache the training data dₙ. As one example, when the free space in the cache data storage unit 46 is equal to or larger than the data size sₙ of the training data dₙ, the cache control unit determines that it is possible to cache the data. When it is possible to cache the data, the processing proceeds to step S227. When it is not possible to cache the data, the processing proceeds to step S220.

[Step S220] The performance predicting unit 41 calculates the speed improvement in prediction performance Pᵢ(Aⱼ) achieved by model searches that have not been performed. This processing is described in detail later (see FIG. 18).

[Step S221] The performance predicting unit 41 calculates the planned number of executions Tᵢ of each learning step based on the speed improvement in prediction performance Pᵢ(Aⱼ).

[Step S222] The performance predicting unit 41 determines that only the learning step n has a planned number of executions Tᵢ that is “1” or greater. When only the learning step n satisfies this condition, the processing proceeds to step S225. When learning steps aside from the learning step n satisfy the condition, the processing proceeds to step S223.

[Step S223] The cache control unit 44 determines whether to cache the training data dₙ of the learning step n designated by the search condition. As one example, the cache control unit 44 deletes cached training data based on the planned number of executions Tᵢ of every learning step Sᵢ whose training data is cached (i.e., “C(i)=true”) and the planned number of executions Tₙ of the learning step n designated by the search condition. As one example, the cache control unit sorts all of the learning steps Sᵢ for which “C(i)=true” and the learning step n designated by the search condition into descending order based on the planned number of executions Tᵢ and the planned number of executions Tₙ. Next, the cache control unit 44 selects the learning steps in order from the front after sorting. When doing so, the cache control unit 44 calculates the total of the data size sₒ of the original data and the data size of the training data of every learning step for which “F(i)=true”. Next, the cache control unit 44 adds the data size of the training data of the selected learning step to the total. When the result of addition is equal to or below the storage capacity of the cache data storage unit 46, the cache control unit 44 sets the flag F(i) of the selected learning step at “true” and selects the next learning step.

When the result of addition is above the storage capacity of the cache data storage unit 46, the cache control unit 44 sets the flag F(i) of the learning steps from the selected learning step onwards in the sorting order at “false”. The cache control unit 44 sets the flag F(i) for every learning step Sᵢ for which the training data has been cached, i.e., “C(i)=true”, and the learning step n designated by the search condition. After this, the cache control unit 44 determines whether “flag F(n)=true” for the learning step n. When “flag F(n)=true”, the cache control unit 44 determines to cache the training data dₙ. Conversely, when “flag F(n)=false”, the cache control unit 44 determines to not cache the training data dₙ.

When the training data dₙ is to be cached, the processing proceeds to step S224. Conversely when the training data dₙ is not to be cached, the processing proceeds to step S228.

[Step S224] The cache control unit 44 deletes training data that is used in a learning step for which “C(i)=true” and “flag F(i)=false” from the cache data storage unit 46. After this, the processing proceeds to step S227.

[Step S225] The cache control unit 44 determines whether the total of the data size sₒ of the original data and the data size sₙ of the training data used in the learning step n designated by the search condition is equal to or below the cache capacity. When the total is equal to or below the cache capacity, the processing proceeds to step S227. Conversely, when the total exceeds the cache capacity, the processing proceeds to step S226.

[Step S226] The cache control unit 44 deletes the original data from the cache. That is, the cache control unit 44 deletes the original data from the cache data storage unit 46.

[Step S227] The cache control unit 44 caches designated by the search condition. That is, the cache control unit 44 stores the training data dₙ in the cache data storage unit 46.

[Step S228] The model searching unit 43 determines whether the end condition of the model search is satisfied. When the end condition is satisfied, the processing ends. When the end condition is not satisfied, the processing proceeds to step S213.

Next, the procedure for calculating the speed improvement in prediction performance will be described.

FIG. 18 is a flowchart depicting one example of the calculation procedure of the speed improvement in prediction performance. The processing depicted in FIG. 18 will now be described in order of the step numbers.

[Step S231] The performance predicting unit 41 specifies the achieved prediction performance. As one example, the performance predicting unit 41 compares the prediction performance that has been achieved so far via a plurality of machine learning algorithms. After this, the performance predicting unit 41 sets the highest value of the prediction performance as the achieved prediction performance.

[Step S232] The performance predicting unit 41 selects one machine learning algorithm that is yet to be processed.

[Step S233] The performance predicting unit 41 estimates the execution time of each unexecuted learning step of the selected machine learning algorithm.

[Step S234] The performance predicting unit 41 estimates the prediction performance of a model obtained by each unexecuted learning step of the selected machine learning algorithm.

[Step S235] The performance predicting unit 41 calculates the performance improvement of each unexecuted learning step of the selected machine learning algorithm. As one example, the performance improvement is a value produced by subtracting the achieved prediction performance from the prediction performance of the learning step being calculated.

[Step S236] The performance predicting unit 41 calculates the speed improvement in prediction performance of each unexecuted learning step of the selected machine learning algorithm. As one example, the speed improvement in prediction performance is a value produced by dividing the performance improvement of the learning step in question by the execution time of the learning step.

[Step S237] The performance predicting unit 41 determines whether every machine learning algorithm has been processed. Also, when the processing of every machine learning algorithm has been completed, the calculation process of the speed improvement in prediction performance ends. When there is an unexecuted machine learning algorithm, the processing proceeds to step S232.

By performing machine learning with the procedure depicted in FIGS. 16 to 18, efficient processing that makes effective use of the cache is performed.

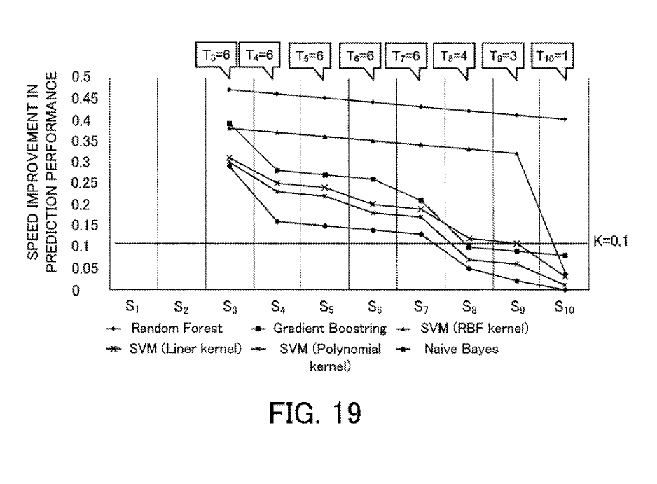

FIG. 19 depicts a fifth example of the planned number of executions for each learning step.

In the example in FIG. 19, after the prediction performance of models has been measured using data of the learning step S₁ and the learning step S₂, the speed improvement in prediction performance is calculated with the threshold K=0.1. Note that training data with 100,000 data units is used in the learning step S₁, 200,000 data units are used in the learning step S₂, . . . , and 51.2 million data units are used in the learning step S₁₀. Not all of the learning steps are executed for every machine learning algorithm. As one example, when there is no expectation of a model with the highest prediction performance obtained so far being exceeded by a model search according to a certain machine learning algorithm, model searches by that machine learning algorithm are cut off and not performed. In the example in FIG. 19, it is assumed that when the speed improvement in prediction performance of a learning step to be executed next by a certain machine learning algorithm is equal to or below the threshold (K=0.1), searches by that machine learning algorithm are cut off.

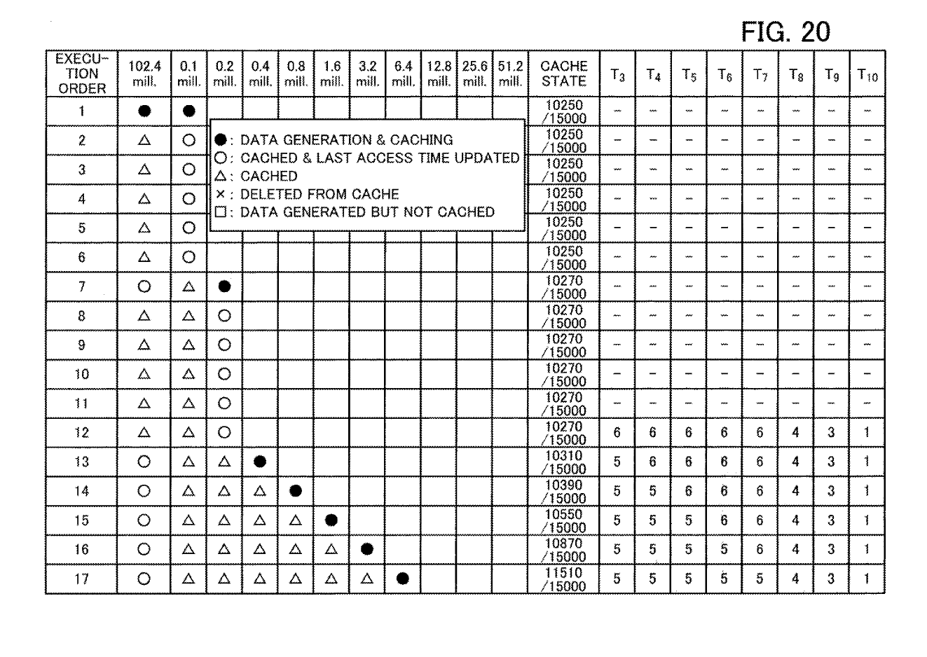

Here, it is assumed that even when a model search according to a machine learning algorithm was actually performed in each learning step, the speed improvement in prediction performance did not change from the initial state. That is, it is assumed that the values of the speed improvement in prediction performance depicted in the graph are accurate. For this case, the execution order and the values of the planned number of executions when execution of each step has ended are as depicted in FIGS. 20 to 22.

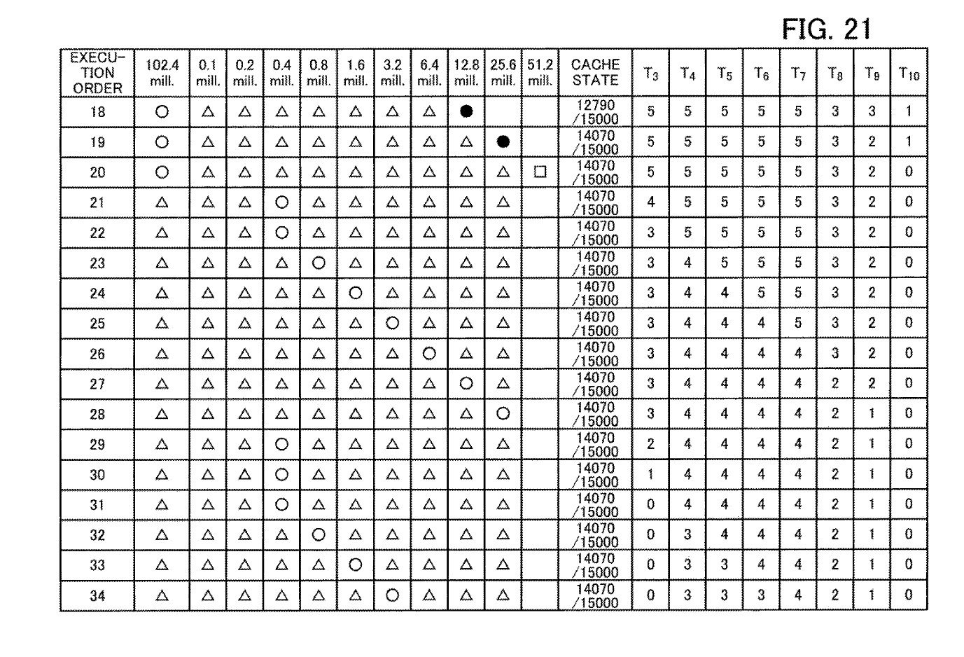

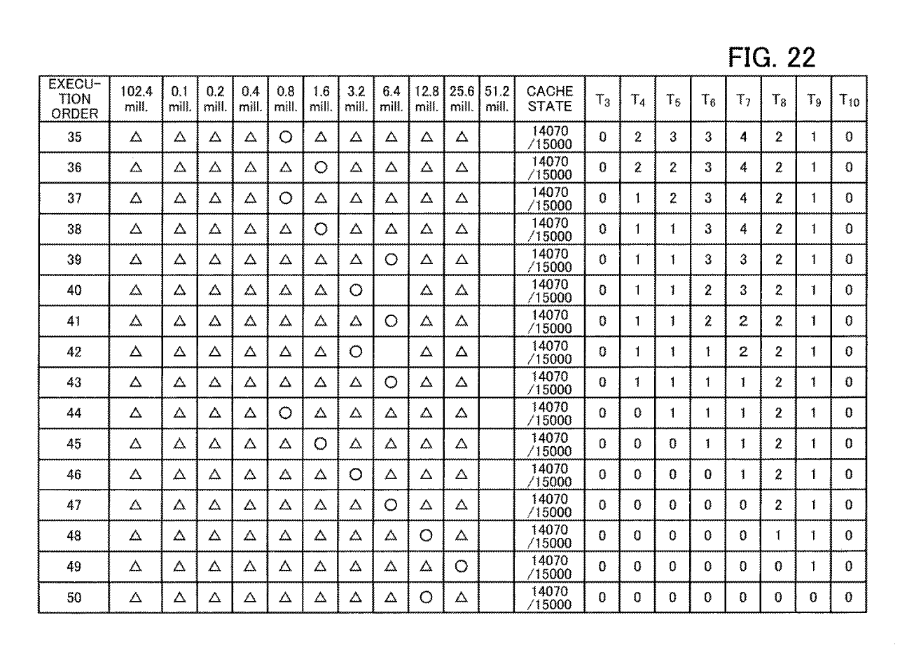

FIG. 20 is a first diagram depicting example transitions in the cache state resulting from cache control according to the second embodiment. FIG. 21 is a second diagram depicting example transitions in the cache state resulting from cache control according to the second embodiment. FIG. 22 is a third diagram depicting example transitions in the cache state resulting from cache control according to the second embodiment.

Here, the cache states according to the LRU policy depicted in FIG. 9 and the cache states depicted in FIGS. 20 to 22 are compared. Although the discarding and subsequent regeneration of data that has been placed once in the cache occurs multiple times in the entire procedure when an LRU policy is used, data is regenerated zero times according to the second embodiment. The regenerated data includes the original data (102.4 million sets) which is the largest, so that the cost incurred by regeneration is large. Also, although the number of times the cache is discarded is sixteen with an LRU policy (the number of cross symbols in the entire procedure), it is zero for the second embodiment.

The second embodiment also has the further effects described below.

With the parallel distributed processing system according to the second embodiment, the speed improvement in prediction performance is recalculated for unexecuted learning steps of every machine learning algorithm every time a model search ends. By doing so, it is possible to precisely estimate which data has the highest potential benefit from caching.

Also, with the parallel distributed processing system according to the second embodiment, the speed improvement in prediction performance is calculated based on information that has been produced by executing each machine learning algorithm up to that time. By doing so, it is possible to calculate the prediction performance more accurately with respect to the actual values. That is, since the curve that expresses changes in the prediction performance used to find the speed improvement in prediction performance is calculated based on the results of actual execution, it is possible to predict the actual value more accurately as the number of values used as a reference increases.

Three effects obtained by updating the speed improvement in prediction performance every time the execution of machine learning proceeds are now described.

A first effect is that it is possible to determine, by accumulating measured values, that it is actually unnecessary to cache training data that was determined as being cached according to the initial prediction of the speed improvement in prediction performance. As a result, it is possible to reduce the processing time that is needed to cache the training data.

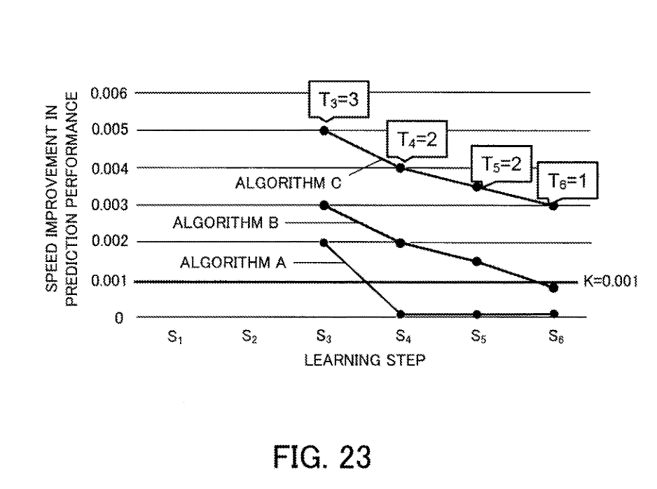

FIG. 23 depicts a first example of initial prediction results. In FIG. 23, prediction results when the speed improvement in prediction performance has been initially predicted after execution of the two learning steps S₁ and S₂ for every machine learning algorithm are depicted.

In the example in FIG. 23, it is expected that the training data of the learning steps S₃, S₄, and S₅ have a high probability of being used two or more times. When this is the case, when the training data of the learning steps S₃, S₄, and S₅ is generated, the training data will be cached.

Here, it is assumed that as a result of executing a model search of the learning step S₃ of “Algorithm C” that has the highest speed improvement in prediction performance, contrary to the prediction, there was hardly any improvement in prediction performance. In this case, “Algorithm C” is excluded from the search candidates due to recalculation of the speed improvement in prediction performance.

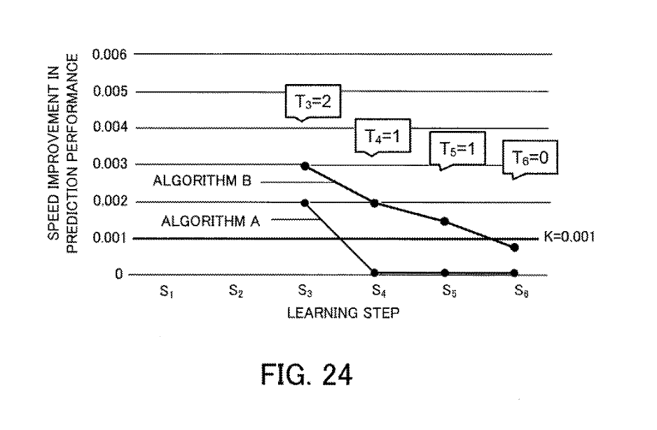

FIG. 24 depicts a first example of the prediction results after measured values have been reflected. FIG. 24 depicts a state after “Algorithm C” has been excluded from the search candidates. In this case, there is no possibility of reuse of the training data of the learning steps S₄ and S₅ that was initially intended to be cached. This means that it is sufficient to cache only the training data of the learning step S₃. As a result, it is possible to eliminate the processing time taken by caching redundant training data.

A second effect is that it is possible to avoid repeated execution of a generation process of training data due to establishing during the actual execution of machine learning that the training data that was initially expected to not need caching actually needs caching.

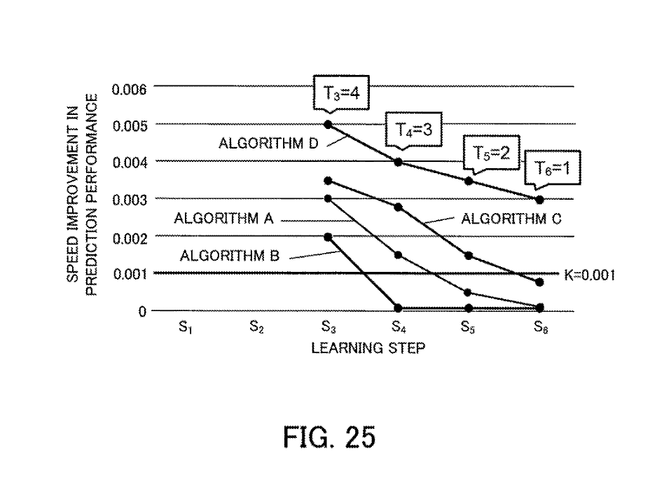

FIG. 25 depicts a second example of initial prediction results. In FIG. 25, prediction results when the speed improvement in prediction performance has been initially predicted after execution of the two learning steps S₁ and S₂ has ended for every machine learning algorithm are depicted.

For the example in FIG. 25, in descending order of speed improvement in prediction performance, the learning steps S₃, S₄, and S₅ of “Algorithm D”, the learning step S₃ of “Algorithm C”, and the learning step S₆ of “Algorithm D” are executed in that order. Here, it is assumed that according to the initial prediction, model searches have been executed as far as learning steps S₅ of “Algorithm D”.

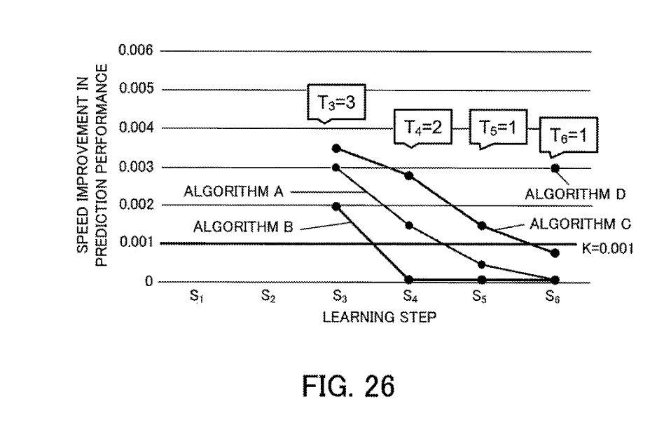

FIG. 26 depicts a second example of the prediction results after measured values have been reflected. FIG. 26 depicts an example of prediction results after execution of model searches up to the learning step S₅ of “Algorithm D”. In the example in FIG. 26, the learning step S₃ of “Algorithm C” is to be executed next.

At this time, it is assumed that a prediction performance that differs from the expected value has been obtained as a result of executing a model search in the learning step S₃ of “Algorithm C”. When the speed improvement in prediction performance is evaluated again before the next model search, the speed improvement in prediction performance of “Algorithm C” is corrected.

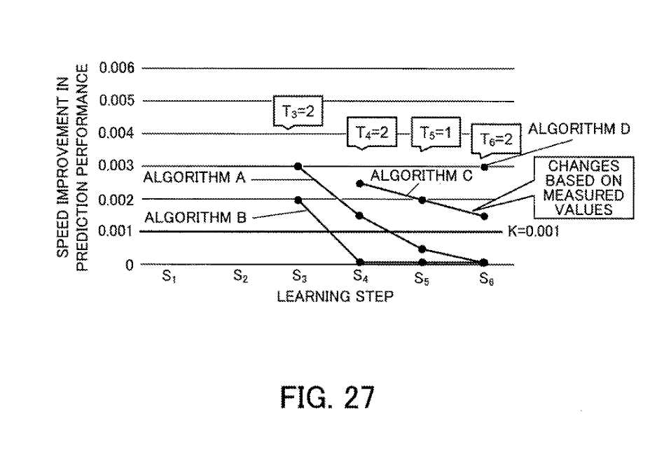

FIG. 27 depicts a third example of the prediction results after measured values have been reflected. FIG. 27 depicts an example of prediction results after execution of a model search in the learning step S₃ of “Algorithm C”. In the example in FIG. 27, the speed improvement in prediction performance from the learning step S₄ of “Algorithm C” onwards changes compared to the state in FIG. 26. As a result, the possibility of the training data of the learning step S₆, which was predicted as being executed only once at the time depicted in FIG. 26, being reused by “Algorithm C” has emerged. This means that it is possible to determine that the training data of the learning step S₆ needs to be cached. By doing so, it is possible to promote the reuse of the cache compared to when reference is made to only the initial prediction results. In particular, since it is possible to reuse data in the learning step S₆ which uses a large amount of data in the example in FIG. 27, there is a large effect in improving the efficiency of processing.

A third effect is that when it is established that sampling will not subsequently be performed from the original data, it becomes possible, by deleting the original data from the cache, to cache a large amount of training data. As one example, with a configuration where deletion of the original data is avoided to give priority to the efficiency with which training data is generated, the storage capacity that is used to store training data falls. As a result, a situation where it is not possible to cache newly generated training data is more likely to occur. With the second embodiment, when deletion of the original data has no effect on the overall processing time, the original data is deleted from the cache and newly generated training data is cached. By doing so, caching and reuse of training data is promoted, thereby achieving an effect of reducing the processing time.

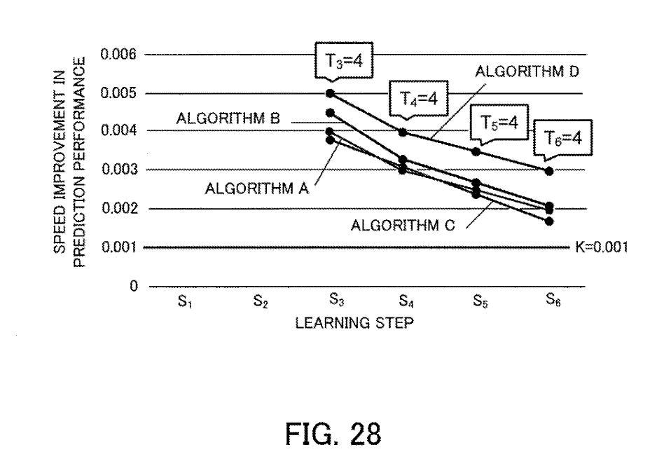

FIG. 28 depicts a third example of initial prediction results. In FIG. 28, prediction results for when the speed improvement has been initially predicted after the execution of the two learning steps S₁ and S₂ have been executed for every machine learning algorithm are depicted. It is assumed that the prediction results depicted in FIG. 28 are actually correct.

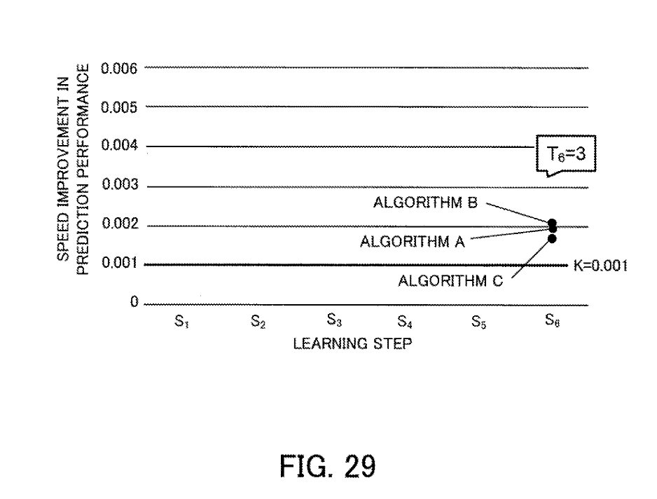

FIG. 29 depicts a fourth example of prediction results after measured values have been reflected. FIG. depicts a state where, in the speed improvement-prioritizing search, model searches are successively performed and only the model search in the learning step S₆ is left. After this, model searches that use the training data of the learning step S₆ are executed in the order “Algorithm B”, “Algorithm A”, and “Algorithm C” and when these searches end, model searches according to all of the conditions are complete.

Here, it is assumed that during the model search according to the learning step S₆ in “Algorithm B”, leaving the original data in the cache results in the free space being insufficient to cache the training data used in the learning step S₆. At this time, when priority is given to keeping the original data in the cache, training data will be regenerated every time a model search that uses the training data of the learning step S₆ is performed. According to the second embodiment, since it is known from the prediction results that the learning step S₆ is the only unexecuted model search, it is possible to determine that it would be more efficient to delete the original data from the cache and cache the training data of the learning step S₆. By caching the training data of the learning step S₆, it is possible to avoid the regeneration of a huge amount of training data such as that used in the learning step S₆ and thereby greatly reduce the time taken by searches.

Note that it is also possible to display how the cache is being efficiently used on the monitor 21.

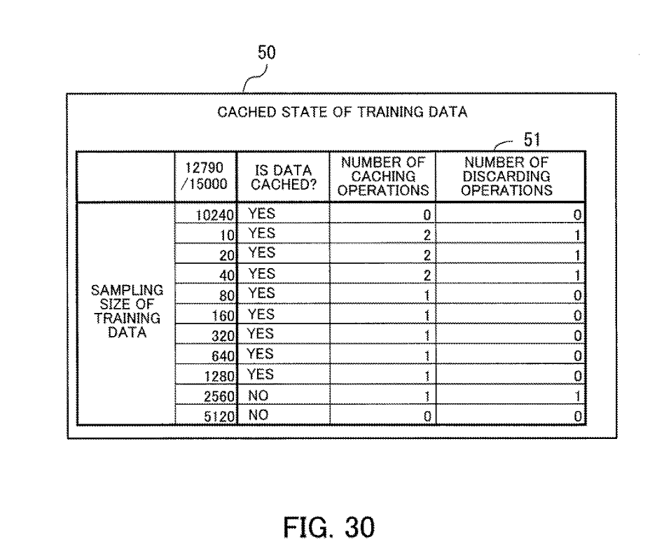

FIG. 30 depicts an example of a display screen for the usage state of the cache. In the screen 50, a table 51 indicating the cache state of the training data is depicted. In the table 51, an indication of whether the data is presently cached, the number of caching operations, and the number of discarding operations from the cache are indicated for each sampling size of training data. Here, the smaller the training data being repeatedly cached, the higher the processing efficiency.

According to the embodiments, it is possible to promote reuse of cached data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a procedure comprising:
generating a plurality of first models by executing a model search according to each of a plurality of machine learning algorithms using first training data out of a plurality of sets of training data that have different sampling rates;
calculating, based on a prediction performance of each of the plurality of first models, an index value to be used to determine whether to generate each of a plurality of second models, which are generated by model searches according to the plurality of algorithms using a plurality of sets of second training data that are included in the plurality of training data but differ from the first training data, the index value being separately calculated for each of the plurality of second models;
setting, for each of the plurality of sets of second training data, a number of second models for which the index value is equal to or above a threshold, out of the second models generated using the second training data, as a priority for caching the second training data;
deciding, when a model search has been executed using a new set of second training data that is not cached, whether to cache the new set of second training data based on the priority of the new set of second training data; and
storing, when the deciding has decided to cache the new set of second training data, the new set of second training data in a memory.

2. The non-transitory computer-readable storage medium according to claim 1,
wherein the deciding includes deciding to cache the new set of second training data when a total data size of the new set of second training data and existing sets of second training data for which the priority is higher than the priority of the new set of second training data, out of one or a plurality of existing sets of second training data that have already been cached, is equal to or smaller than a capacity of the memory.

3. The non-transitory computer-readable storage medium according to claim 2,
wherein the deciding includes deciding, when it has been decided to cache the new set of second training data and the total data size of the new set of second training data and the one or plurality of existing sets of second training data exceeds a capacity of the memory, to delete existing sets of second training data whose priority is lower than the priority of the new set of second training data from the memory.

4. The non-transitory computer-readable storage medium according to claim 1,
wherein the calculating includes recalculating, whenever a model search using second training data is executed, the index value for each yet-to-be-generated second model based on a prediction performance of each of the plurality of first models and a prediction performance of existing second models that have already been generated.

5. The non-transitory computer-readable storage medium according to claim 1,
wherein the deciding includes deciding, when original data that is used to generate the plurality of sets of training data is being cached, the new set of second training data is only second training data with a priority of one or higher, and the total data size of the original data and the new set of second training data exceeds a capacity of the memory, to delete the original data from the memory.

6. The non-transitory computer-readable storage medium according to claim 1,
wherein the calculating includes calculating, for each of the plurality of second models, a speed improvement in prediction performance based on an execution time when generating the second model and a prediction performance of said each second model, and setting the speed improvement as the index value of the second model.

7. The non-transitory computer-readable storage medium according to claim 1, wherein the procedure further includes:
selecting a target second model to be generated out of the plurality of second models based on respective index values of the plurality of second models; and
generating the target second model by executing a model search according to a machine learning algorithm for generating the target second model using second training data for generating the target second model.

8. The non-transitory computer-readable storage medium according to claim 1,
wherein the threshold is a value of the index value used as a determination standard for determining whether to generate each of the plurality of second models.

9. A machine learning management method comprising:
generating, by a processor, a plurality of first models by executing a model search according to each of a plurality of machine learning algorithms using first training data out of a plurality of sets of training data that have different sampling rates;
calculating, by the processor and based on a prediction performance of each of the plurality of first models, an index value to be used to determine whether to generate each of a plurality of second models, which are generated by model searches according to the plurality of algorithms using a plurality of sets of second training data that are included in the plurality of training data but differ from the first training data, the index value being separately calculated for each of the plurality of second models;
setting, by the processor and for each of the plurality of sets of second training data, a number of second models for which the index value is equal to or above a threshold, out of the second models generated using the second training data, as a priority for caching the second training data;
deciding, by the processor when a model search has been executed using a new set of second training data that is not cached, whether to cache the new set of second training data based on the priority of the new set of second training data; and
storing, when the deciding has decided to cache the new set of second training data, the new set of second training data in a memory.

10. A machine learning management apparatus comprising:
a memory; and
a processor configured to perform a procedure including:
generating a plurality of first models by executing a model search according to each of a plurality of machine learning algorithms using first training data out of a plurality of sets of training data that have different sampling rates;
calculating, based on a prediction performance of each of the plurality of first models, an index value to be used to determine whether to generate each of a plurality of second models, which are generated by model searches according to the plurality of algorithms using a plurality of sets of second training data that are included in the plurality of training data but differ from the first training data, the index value being separately calculated for each of the plurality of second models;
setting, for each of the plurality of sets of second training data, a number of second models for which the index value is equal to or above a threshold, out of the second models generated using the second training data, as a priority for caching the second training data;
deciding, when a model search has been executed using a new set of second training data that is not cached, whether to cache the new set of second training data based on the priority of the new set of second training data; and
storing, when the deciding has decided to cache the new set of second training data, the new set of second training data in the memory.
